(19) United States
(12) Patent Application Publication
(10) Pub. No.: US 2024/0191078 A1
(43) Pub. Date: Jun. 13, 2024

(54) ULTRAVIOLET-RAY-CURABLE COMPOSITION AND USE THEREOF

(71) Applicants: DOW TORAY CO., LTD., Shinagawa-ku, Tokyo (JP); DOW SILICONES CORPORATION, Midland, MI (US)

(72) Inventors: Takuya OGAWA, Ichihara-shi, Chiba (JP); Wenbin LIANG, Ichihara-shi, Chiba (JP); Tomohiro IIMURA, Ichihara-shi, Chiba (JP); EunKyung JANG, Jincheon-Gunn, Chungbuk (KR); Jaehoon JEONG, Jincheon-Gunn, Chungbuk (KR)

(21) Appl. No.: 18/283,294

(22) PCT Filed: Mar. 25, 2022
(86) PCT No.: PCT/JP2022/014393

§ 371 Date: Dec. 12, 2023

(30) Foreign Application Priority Data
Mar. 26, 2021 (JP) 2021-053363

(51) Int. Cl. C08L 83/04; C08F 220/18; C08G 77/04; C08L 33/08

(52) U.S. Cl. CPC C08L 83/04; C08F 220/1811; C08G 77/04; C08L 33/08

(57) ABSTRACT

Provided is a UV curable organopolysiloxane composition containing silicon atoms. A product obtained by curing the composition has low light transmittance in a predetermined UV wavelength range, and excellent workability when applied to a substrate. The UV curable composition of the present disclosure comprises: (S) 90 to 99.99 parts by mass of one or more of the following component (S1) or component (S2); (S1) an organopolysiloxane and/or organosilane having a UV curable functional group, (S2) a mixture containing (A) a compound with a UV curable functional group, with or without silicon atoms, and (B) an organopolysiloxane without a UV curable functional group, at a mass ratio of 5:95 to 95:5; and (C) 0.01 to 10 parts by mass of a UV absorbing compound. The total of component (S) and component (C) is 100 parts by mass.

### TECHNICAL FIELD

The present invention relates to a UV curable composition curable by chemical rays (actinic rays), for example ultraviolet light or electron beam, in particular relates to UV curable compositions containing organosilicon compounds, preferably organopolysiloxanes, and in particular relates to UV curable compositions wherein cured products obtained therefrom have low viscosity, excellent application properties, and a have UV shielding function. The curable composition of the present invention is suitable as an insulating material for electronic and electrical devices, and particularly as a material for use as a coating agent. Furthermore, the composition has excellent application properties and superior wettability to substrates, thus being useful as an injection molding material and inkjet printing material.

### BACKGROUND ART

Due to high heat resistance and excellent chemical stability, silicone resins have been used as coating agents, potting agents, insulating materials, and the like for electronic and electrical devices. Silicone resins include UV curable silicone compositions.

Touch panels are used in various display devices such as mobile devices, industrial equipment, car navigation systems, and the like. In order to improve detection sensitivity, electrical influence from light emitting sites such as light emitting diodes (LED) and organic light emitting devices (OLED) must be suppressed, and an insulating layer is usually placed between the light emitting part and the touchscreen.

On the other hand, thin display devices such as OLEDs have a structure in which a plurality of functional thin layers are stacked. In recent years, studies have been started in order to improve the overall reliability of display devices, especially flexible display devices, by laminating an insulating layer with a UV shielding function onto the touchscreen layer. In addition, the inkjet printing method has been adopted as a processing method for organic layers to improve productivity. Therefore, a material that can be processed by the inkjet printing method is required for the aforementioned insulating layer.

UV curable resin compositions containing compounds with UV absorption functions are known. For example, Patent No. 6729776 discloses a UV absorbing material that is a salt product of an acrylic resin with cationic groups and an anionic dye, and an acrylic light curing composition containing this material. Although this composition has a UV absorption function at 380 to 400 nm, the composition is diluted in a solvent, and is unsuitable for pour molding and inkjet printing methods.

In addition, Japanese Unexamined Patent Application 2019-194309 and Japanese Unexamined Patent Application 2020-139108 disclose acrylic pressure-sensitive adhesive compositions for an image display device that contain UV absorbing agents. None of these compositions can be applied by the inkjet printing method due to the high viscosity.

### PRIOR ART DOCUMENTS

### Patent Documents

Patent Document 1: Japanese Patent No. 6729776
Patent Document 2: Japanese Unexamined Patent Application 2019-194309
Patent Document 3: Japanese Unexamined Patent Application 2020-139108

### SUMMARY OF THE INVENTION

### Problem to be Solved by the Invention

As described above, UV curable resin compositions with UV absorption function are well known, but there is still a need for UV curable compositions with easy adjustment of the mechanical properties of the cured material and excellent workability, especially low viscosity, for application to substrates. The present invention seeks to provide a curable composition containing silicon atoms, especially a UV curable composition, especially a UV curable organopolysiloxane composition, that has excellent workability when applied to a substrate, a function for absorbing ultraviolet light, especially ultraviolet light with a wavelength of 360 to 400 nm, and with highly adjustable mechanical properties of the molded body obtained by curing.

### Means for Solving the Problem

The present invention was achieved by discovering that a UV curable composition obtained by using a compound (C) having a UV curable function and a component (S) containing at least one organosilicon compound selected from the following (S1) or (S2) will have favorable UV absorbing function, low viscosity, and excellent workability when applied to a substrate, and a cured product thereof will exhibit excellent mechanical adjustment properties:
(S1) an organopolysiloxane and/or organosilane having a UV curable functional group; and
(S2) a mixture containing (A) a compound with a UV curable functional group, with or without silicon atoms, and (B) an organopolysiloxane without a UV curable functional group.

In particular, the present invention relates to a UV curable composition obtained by 90 to 99.99 parts by mass of component (S) including one or more components selected from the group consisting of the following components (S1) and one or more components selected from the group consisting of components (S2):
(S1) an organopolysiloxane and/or organosilane having a UV curable functional group, and
(S2) a mixture containing (A) a compound with a UV curable functional group, with or without silicon atoms, and (B) an organopolysiloxane without a UV curable functional group, at a mass ratio of 5:95 to 95:5 (A:B); and
0.01 to 10 parts by mass of (C) a UV absorbent compound (where the total of component (S), and component (C) is 100 parts by mass), and this UV curable composition has favorable UV absorbing function, low viscosity, and excellent viscosity when applied to a substrate, and a cured product thereof will exhibit excellent mechanical property adjusting function.

The UV curable composition of the present invention is preferably a UV curable organopolysiloxane composition in which component (S) includes an organopolysiloxane having a UV curable functional group (S1) or an organopolysiloxane not having a UV curable functional group (B).

When the aforementioned UV curable composition of the present invention is applied to an arbitrary substrate such that the thickness after curing is 10 μm and then irradiated with light such that the integrated light intensity at least at one wavelength selected from wavelength 365 to 405 nm is 2 to 8 J/cm², carrying of the composition can be achieved either when irradiation is completed or within 5 minutes thereof, the light transmittance at a wavelength of 450 nm of the cured product obtained with a thickness of 10 μm is 98% or higher, and the light transmittance is 50% or less at least one point within the wavelength range of 360 to 405 nm.

Herein, the meaning of “the light transmittance is 50% or less at least one point within the wavelength range of 360 to 405 nm” is that the light transmittance will be 50% or less at least one point within the wavelength range of 360 to 405 nm when the light transmittance of the cured product is measured across a wavelength range of 300 to 800 nm. Furthermore, the meaning of “the UV curable composition is cured” is that the composition does not stick to a finger when the finger touches the surface of the composition after light irradiation.

The curable composition of the present invention is cured by forming a bond by a UV curable functional group. However, the curing method is not limited to light irradiation such as UV irradiation, and an arbitrary method in which a UV curable functional group can cause a curing reaction can be used. For example, electron beam irradiation may be used to cure the composition of the present invention.

The curable composition of the present invention is preferably substantially free of organic solvents.

The curable composition of the present invention preferably has a viscosity of 500 mPa·s or less for the entire composition when measured at 25° C. using an E-type viscometer.

The wavelength range of the cured product with a thickness of 10 μm obtained from the curable composition preferably exhibits the lowest light transmittance from 385 to 400 nm. The wavelength range of 385 to 400 nm, which shows the lowest light transmittance, is the wavelength range in which the light transmittance of the cured product exhibits the lowest light transmittance within the measured wavelength range of 300 nm to 800 nm.

The UV absorbent composition which is component (C) in the curable composition is preferably a compound having a maximum absorption wavelength in the wavelength range of 340 to 420 nm.

The compound having a silicon atom and having component (S1) and the UV curable functional group of (A) of component (S2) preferably is an organosilicon compound selected from the group straight chain, branched, and cyclic organosilanes and organopolysiloxanes expressed by the average composition formula:

R_{c}R′_{d}SiO_{(4-c-d)/2} (2)
(where R is a UV curable functional group;
R′ is a group selected from monovalent hydrocarbons, hydroxyl groups, and alkoxy groups excluding the UV reactive UV curable functional group;
c and d are numbers that satisfy the following conditions: 1<c+d≤4 and 0.05≤c/(c+d)≤ 0.25, and the number of R in the molecule is 1).

Component (S1) and compound (A) of component (S2) having a UV curable functional group and having a silicon atom are preferably a straight chain, branched, or cyclic organopolysiloxanes expressed by the average composition formula:

RₐR′_{b}SiO_{(4-a-b)/2} (1)
(where R is a UV curable functional group;
R′ is a group selected from monovalent hydrocarbons, hydroxyl groups, and alkoxy groups excluding the UV curable functional group;
a and b are numbers that satisfy the following conditions: 1≤a+b≤3 and 0.01≤a/(a+b)≤ 0.34, and the number of R in the molecule is 2).

Component (S1) and compound (A) of component (S2) having a UV curable functional group and having a silicon atom are preferably an organopolysiloxane and/or an organosilanes having one UV curable functional group in a molecule, selected from a group consisting of:
organopolysiloxanes expressed by the following formula (3′):

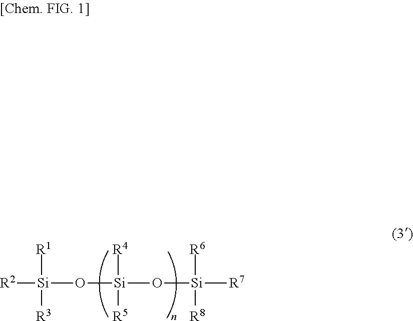

(where in formula (3′), of all R¹ to R⁸ groups, only one UV curable functional group is present in the molecule; the other of R¹ to R⁸ groups are independently a monovalent hydrocarbon group unsubstituted or substituted with fluorine; and n is a numerical value that is 0 or higher and 3 or lower);
cyclic organopolysiloxanes expressed by the following formula (5′):

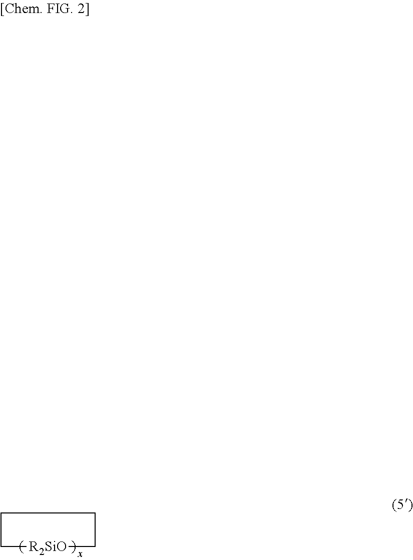

(where in formula (5′), R is independently a group selected from UV curable functional groups and monovalent hydrocarbon groups unsubstituted or substituted with fluorine, x is an integer of 3 to 5, and only one UV curable functional group is provided in the molecule); and
organosilanes expressed by the following formula (6):

RSiR′₃ (6)
(where in formula (6), R is a UV curable functional group, and R′ is a group selected from monovalent hydrocarbon groups, hydroxyl groups, and alkoxy groups excluding the aforementioned UV curable functional groups).

Component (S1) and compound (A) of component (S2) having a UV curable functional group and having a silicon atom are preferably one or more organopolysiloxane having one UV curable functional group in a molecule, selected from a group consisting of:
organopolysiloxanes expressed by the following formula (3):

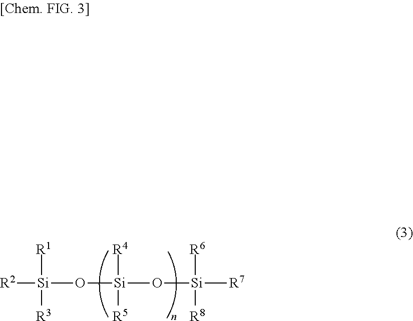

(where in formula (3), two or more of all R¹ to R⁸ groups in one molecule are UV curable functional groups; other R¹ to R⁸ groups are independently, monovalent hydrocarbon groups unsubstituted or substituted with fluorine; and n is a numerical value such that the viscosity of the organopolysiloxane expressed by Formula (3) is 1 to 1000 mPa·s at 25° C., and n may be 0); and
organopolysiloxanes expressed by average unit formula:

(R₃SiO_{1/2})ₑ(R₂SiO_{2/2})_{f}(RSiO_{3/2})_{g}(SiO_{4/2})ₕ (4)
(where in formula (4), R is independently a group selected from UV curable functional groups, monovalent hydrocarbon groups unsubstituted or substituted with fluorine, at least two of all Rs are UV curable functional groups, (g+h) is a positive number, e is 0 or a positive number, and f is a number within a range of 0 to 20);
cyclic organopolysiloxanes expressed by the following formula (5):

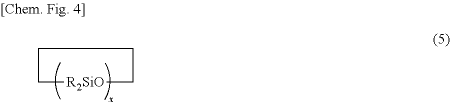

(where in formula (5), R is independently a group selected from UV curable functional groups and monovalent hydrocarbon groups unsubstituted or substituted with fluorine, x is an integer of 3 to 10, and two or more UV curable functional groups are provided in the molecule); and
mixtures of two or more organopolysiloxanes arbitrarily selected therefrom.

In one preferred aspect of the present invention, the number of UV curable functional groups of component (S1) in the curable composition is on average two per molecule.

In one preferred aspect of the present invention, the component (S1) in the curable composition is an organopolysiloxane having one UV curable functional group in the molecule.

The UV curable functional group of component (S1) and compound (A) in the composition of the present invention is preferably a functional group selected from the group consisting of acryloxy group-containing groups, methacryloxy group-containing groups, epoxy group-containing groups, oxetane group-containing groups, and vinylether group-containing groups.

In one preferred aspect of the curable composition of the present invention, the curable composition preferably contains component (S1) as component (S). Furthermore, component (S1) is preferably an epoxy-functional organopolysiloxane.

In one preferred aspect of the curable composition of the present invention, the curable composition preferably contains component (S2) as component (S). More preferably, Component (S2)(A) is a compound having an acryloxy group.

In the curable composition containing the aforementioned component (S2), component (B) is preferably an organopolysiloxane having an alkenyl group.

In one preferable aspect of the aforementioned curable composition, the curable composition includes component (S2), and component (A) is a compound that does not contain a silicon atom.

In one preferable aspect of the aforementioned curable composition, the curable composition includes component (S2), and component (A) is a compound that does contain a silicon atom.

In one preferred aspect of the curable composition of the present invention, the curable composition preferably includes component (S1) as component (S), wherein component (S1) is a mixture containing:
(S1-1) one or more organopolysiloxanes having on average two or more epoxy-containing groups per molecule, and
(S1-2) one or more organosilicon compounds selected from the group consisting of one or more organopolysiloxanes and/or organosilanes having one epoxy group-containing group per molecule,
such that the mass ratio (S1-1/S1-2) of component (S1-1) and component (S1-2) is 100/0 to 0/100.

In one preferred aspect of the curable composition of the present invention, the curable composition contains component (S1) as component (S), and component (S1) is:
(S1-2-1) 1,1,1,3,5,5,5-heptamethyl-3-[2-(3,4-epoxycyclohexyl)ethyl]trisiloxane; or
a mixture of (S1-2-1) 1,1,1,3,5,5,5-heptamethyl-3-[2-(3,4-epoxycyclohexyl)ethyl]trisiloxane and at least one compound selected from the following (S1-1-1) group, wherein the mass ratio is in a range of 100/0 to 0/100 (amount of S-2-1/total amount of the compound selected from the S1-1-1 group);

### (S1-1-1):

1,3-bis[2-(3,4-epoxycyclohexyl)ethyl]-1,1,3,3-tetramethyldisiloxane, 1,5-bis[2-(3,4-epoxycyclohexyl)ethyl]-1,1,3,3,5,5-hexamethyltrisiloxane, 1,1,3,3,5,5,7,7,9,9-decamethyl-1,9-bis[2-(3,4-epoxycyclohexyl)ethyl]pentasiloxane, methyl(tris[2-(3,4-epoxycyclohexyl)ethyl]dimethylsiloxy)silane, tetrakis([2-(3,4-epoxycyclohexyl)ethyl]dimethylsiloxy)silane, 1,3,5,7-tetramethyl-1,3,5,7-tetra[2-(3,4-epoxycyclohexyl)ethyl]-cyclotetrasiloxane, 1,3-bis(3-glycidoxypropyl)-1 1,3,3-tetramethyldisiloxane, 1,5-bis(3-glycidoxypropyl)-1,1,3,3,5,5-hexamethyltrisiloxane, 1,1,3,3,5,5,7,7,9,9-decamethyl-1,9-bis(3-glycidoxypropyl)pentasiloxane, methyl[tris(3- glycidoxypropyl)dimethylsiloxy]silane, tetrakis[(3-glycidoxypropyl)dimethylsiloxy]silane, and 1,3,5,7-tetramethyl-1,3,5,7-tetra(3-glycidoxypropyl)-cyclotetrasiloxane.

In one preferred aspect of the curable composition of the present invention, the curable composition contains as component (S) component (S2) including component (A) and component (B), wherein component (A) is a compound having one acryloxy group as a UV curable functional group, or a mixture of two or more compounds having one acryloxy group.

In one preferred aspect of the curable composition of the present invention, the curable composition contains component (S2), and component (A) in the composition is a mixture of one or more type of acryloxy group as a UV curable functional group, or a mixture of one or more compound having one acryloxy group as the UV curable functional group, and one or more type of compound having two or more acryloxy groups.

In one preferred aspect of the curable composition of the present invention, the curable composition contains as component (S) component (S2) including component (A) and component (B), wherein component (A) is a compound having one or more acryloxy group, but that does not have a silicon atom.

In one preferred aspect of the curable composition of the present invention, the curable composition contains, as component (S), component (S2) including component (A) and component (B), wherein component (B) is one or more components selected from the group consisting of component (B1) and (B2):
(B1) organopolysiloxane having three or more alkenyl groups in one molecule and no UV curable functional groups; and
(B2) organopolysiloxane having two or more alkenyl groups in one molecule but not having a UV curable functional group, where the amount of vinyl groups is 5% or more by mass.

In one preferred aspect of the curable composition of the present invention, the curable composition contains, as component (S), component (S2) containing component (A) and component (B), wherein component (B) is a straight-chain, branched, or cyclic organopolysiloxane expressed by the average composition formula:

RₐR′_{b}SiO_{(4-a-b)/2} (7)
(In formula (7), R is an alkenyl group;
R′ is a group selected from monovalent hydrocarbon groups excluding alkenyl groups, hydroxyl groups, and alkoxy groups;
a and b are numbers that satisfy the following conditions: 1≤a+b<3 and 0.1≤a/(a+b)≤1.0, and at least two Rs are present in a molecule.)

In one preferred aspect of the curable composition of the present invention, the curable composition contains, as component (S), component (S2) containing component (A) and component (B), wherein the organopolysiloxane of component (B) is one or more type of organopolysiloxanes having 2 or more alkenyl groups in the molecule selected from a group consisting of: organopolysiloxanes expressed by the following formula (8):

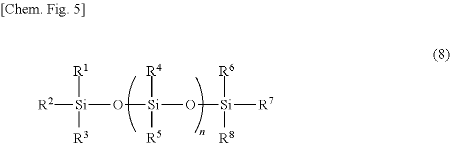

(where in formula (8), of all R¹ to R⁸ groups, two or more alkenyl groups are present in the molecule; the other groups of R¹ to R⁸ are independently monovalent hydrocarbon groups that are unsubstituted or substituted with fluorine; and n is a numerical value that is 1 or more and 1000 or less);
organopolysiloxanes expressed by the following average unit formula:

(R₃SiO_{1/2})ₑ(R₂SiO_{2/2})_{f}(RSiO_{3/2})_{g}(SiO_{4/2})ₕ (9)
(In formula (9), R is independently a group selected from alkenyl groups and monovalent hydrocarbon groups that are unsubstituted or substituted with fluorine, at least two of all Rs are alkenyl group, (g+h) is a positive number, e is 0 or a positive number, and f is a number within a range of 0 to 100);
cyclic organopolysiloxanes expressed by the following formula (10):

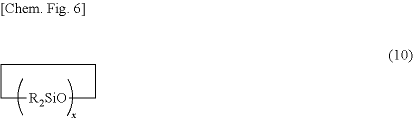

(in formula (10), R independently represents a group selected from alkenyl groups and monovalent hydrocarbon groups that are unsubstituted or substituted with fluorine, x is an integer between 3 and 10, and at least 2 groups in the molecule are alkenyl groups); and
mixtures of these organopolysiloxanes.

In one preferred aspect of the curable composition containing component (B) according to the present invention, component (B) includes an organopolysiloxane having (RSiO_{3/2}) units.

In one preferred aspect of the curable composition containing component (B) according to the present invention, component (B) is an organopolysiloxane having 3 or more alkenyl groups in one molecule.

If component (B) is an organopolysiloxane having an alkenyl group as described above, the alkenyl group of component (B) preferably is an alkenyl group with 3 to 8 carbon atoms.

Although the viscosity of the aforementioned curable composition of the present invention can be set appropriately according to the application, the viscosity of the entire composition measured at 25° C. using an E-type viscometer is preferably in a range of 5 to 60 mPa·s, more preferably in a range of 5 to 30 mPa·s.

The present invention also provides a cured product obtained by curing the aforementioned UV curable composition.

The cured product obtained from the UV curable composition of the present invention and having a thickness of 10 μm thickness preferably has a lowest value of light transmittance of 25% or less in a wavelength range 360 to 405 nm.

The cured product obtained from the UV curable composition of the present invention and having a thickness of 10 um thickness more preferably has a lowest value of light transmittance of 10% or less in a wavelength range 360 to 405 nm.

The present invention further provides an insulating coating agent containing the aforementioned UV curable composition. The UV curable composition of the present invention is useful as an insulating coating agent.

The present invention further provides a method for using the cured product of the aforementioned UV curable composition as an insulating coating layer.

The present invention further provides a display device such as a liquid crystal display, organic EL display, or organic EL flexible display that include a layer containing a cured product of the aforementioned UV curable composition.

### Mode for Carrying Out the Invention

A configuration of the present invention will be further described in detail below. The UV curable composition of the present invention includes 90 to 99.99 parts by mass (total amount of component (S)) of one or more of the following components selected from component (S1) and component (S2); (S1) an organopolysiloxane and/or organosilane having a UV curable functional group, (S2) a mixture containing (A) a compound with a UV curable functional group, with or without silicon atoms, and (B) an organopolysiloxane without a UV curable functional group, at a mass ratio of 5:95 to 95:5; as well as 0.01 to 10 parts by mass of a (C) a UV absorbing compound (the total of component (S) and component (C) is 100 parts by mass), wherein when the composition is applied to an arbitrary substrate so that the thickness after curing is 10 μm, and light irradiation is performed such that the integrated light intensity at least at one wavelength selected from 365 to 405 nm is 2 to 8 J/cm², the composition can be cured upon completion of irradiation or within 5 minutes thereafter; and the resulting cured material with a thickness of 10 μm has a light transmittance of 98% or more at a wavelength of 450 nm and a light transmittance of 50% or less at least at one point in the wavelength range of 360 to 405 nm.

In addition to the aforementioned component (S) and component (C), the UV curable composition of the present invention may optionally contain additional components selected from photo-radical polymerization initiators and various additives.

In the present specification, the term “polysiloxane” refers to a siloxane unit (Si—O) with a degree of polymerization of two or more, in other words with an average of two or more Si—O bonds per molecule. Polysiloxanes include siloxane oligomers such as disiloxanes, trisiloxanes, tetrasiloxanes, and the like, as well as siloxane polymers with higher degrees of polymerization.

The UV curable composition may be diluted with an organic solvent, but preferably is free of organic solvents. Free of organic solvent means that the amount of organic solvents is less than 0.05% by mass of the total composition, preferably less than the analytical limit of analytical methods such as gas chromatography or the like. In the present invention, the desired viscosity can be achieved without the use of organic solvents by adjusting the molecular structure and molecular weight of component (S1), component (A), and component (B).

Component (S) of the present invention is the main component of the UV curable composition. In one aspect of the present invention, the curable composition contains (S1) an organopolysiloxane and/or organosilane having a UV curable functional group as component (S). In one aspect of the present invention, the curable composition contains (S2) a mixture containing (A) a compound with a UV curable functional group, with or without a silicon atom, and (B) an organopolysiloxane without a UV curable functional group, at a mass ratio of 5:95 to 95:5 as component (S). The curable composition of the present invention contains either component (S1) or component (S2), but other optional components may be added provided that the component does not correspond to a combination of (S1) and (S2). For example, a compound having a UV curable functional group and not having a silicon atom may also be added to component (S1).

Any known UV curable organic group can be used as the UV curable functional group of component (S1) and component (A) in the curable composition. Acryloxy group-containing groups, methacryloxy group-containing groups, epoxy group-containing groups, oxetane group-containing groups, vinylether group-containing groups, and maleimide group-containing groups are examples of the UV curable functional groups, but acryloxy group-containing groups and epoxy group-containing groups can be preferably used, from the perspective of the ease of producing the material and the UV curing properties. In other words, UV curable organosilicon compounds selected from the group consisting of acryloxy group functional polysiloxanes, epoxy group functional polysiloxanes, acryloxy group functional organosilanes, epoxy group functional organosilanes, and any mixture thereof, are preferred as component (S1). In particular, one or more organosilicon compound selected from the group consisting of epoxy group functional polysiloxanes and epoxy group functional organosilanes can be particularly preferably used as component (S1). Furthermore, another aspect of the curable composition of the present invention includes component (S2), a mixture of component (A) and component (B) in a ratio of 5:95 to 95:5 (by mass), as component (S). Compounds that can be used as component (A) are any compound that has a UV curable functional group either with a silicon atom or without a silicon atom, and the structure is not particularly limited. However, use of a compound selected from acryloxy group functional organic compounds and epoxy group functional organic compounds is preferable, and use of an acryloxy group functional organic compound is particularly preferable. Furthermore, component (B) used in combination with component (A) is an organopolysiloxane without a UV curable functional group, and the structure is not particularly limited, but an organopolysiloxane having an alkenyl group in the molecule is preferable, particularly one having two or three or more alkenyl groups in the molecule.

The aforementioned component (S1) of the present invention preferably includes one or more organopolysiloxanes (S1-A) having on average two or more UV curable functional groups in one molecule, and/or one or more organopolysiloxane and/or organosilane having one UV curable functional group in one molecule. Preferably, an organosilane (S1-B) is included at a mass ratio of 100/0 to 0/100 (S1-A/S1-B). The mass ratio is preferably 80/20 to 0/100 (S1-A/S1-B). Particularly preferable compounds of component (S1-A) are organopolysiloxanes (S1-1) having an epoxy-containing group as the UV curable functional group, and particularly preferable compounds of component (S1-B) are organopolysiloxanes and/or organosilanes (S1-2) having an epoxy-containing groups as the UV curable functional groups. The use of only component (S1-2) as component (S1) is another preferred aspect. If the aforementioned component (S1) is a component having only one UV curable functional group per molecule (for example, includes only the aforementioned component (S1-B)), (D) a compound having one or more, preferably two or more, UV curable functional groups and not have a silicon atom is preferably included as a crosslinking component. Note that if component (S1) contains (S1-A) one or more organopolysiloxanes having on average two or more UV curable functional groups per molecule, the crosslinking reaction will proceed as a whole composition, even if component (D) is not present. In other words, component (D) is a cross-linking component that may be optionally used depending on the type of component (S1).

The viscosity of component (S1) at 25° C. is preferably 1 to 1000 mPa·s, especially 1 to 500 mPa·s, more preferably 5 to 100 mPa·s, especially 5 to 60 mPa·s, and most preferably 5 to 30 mPa·s.

Furthermore, component (S1) contains 1 to 20, preferably 1 to 12, more preferably 1 to 8, and most preferably 1 to 5 silicon atoms per molecule.

The foregoing was an overview of the composition of the UV curable composition of the present invention, and each component will be described below in more detail.

### [Component (S)]

Component (S) is a main component of the curable composition, and can be one or more compound selected from component (S1) or one or more compound selected from component (S2).

### [Component (S1)]

As described above, component (S1) can be (S1-A) one or more organopolysiloxane having on average two or more UV curable functional groups in a molecule, (S1-B) one or more organopolysiloxane and/or organosilane having one UV curable functional group in a molecule, or any arbitrary mixture thereof.

### <Component (S1-A): A Polysiloxane Having an Average of Two or More UV Curable Functional Groups in a Molecule>

The polysiloxane of component (S1-A) is an organopolysiloxane that is straight chain, branched, or cyclic, preferably straight chain or branched, and particularly preferably straight chain organopolysiloxane, expressed by the following average composition formula:

RₐR′_{b}SiO_{(4-a-b)/2} (1).

In formula (1), R is a UV curable functional group,
R′ is a group selected from monovalent hydrocarbon groups excluding UV curable functional groups, hydroxyl groups, and alkoxy groups, and
a and b are numbers that satisfy the following conditions: 1≤a+b≤3 and 0.01≤a/(a+b)≤0.34, preferably 2≤a+b≤3 and 0.05≤a/(a+b)≤0.34, and at least two Rs are provided in a molecule).

The UV curable functional group expressed by R in formula (1) is an organic group capable of generating a bond between each other by UV irradiation in the presence or absence of a photoinitiator. Examples of the UV curable functional groups can include radical polymerizable groups and cationic polymerizable groups. Radical polymerizable groups are not particularly limited so long as they are a functional group that can form a new bond by a radical reaction mechanism, and particularly a bond between radical polymerizable groups. Examples can include acrylic groups, methacrylic groups, maleimide groups, and organic groups containing any of these groups. Specific examples of the radical polymerizable group include groups such as acryloxypropyl, methacryloxypropyl, acrylamidopropyl, methacrylamidopropyl, 3-(N-maleimido)propyl, and the like. Acryloxy group-containing groups are preferable as the radical polymerizable group. Examples of cationic polymerizable groups include vinyl ether groups, epoxy group-containing groups, oxetane group-containing groups, and other groups, such as CH₂═CH—O—(CH₂)ₙ— (where n is an integer from 3 to 20), glycidyloxy-(CH₂)ₙ— (where n is an integer from 3 to 20), 3,4-epoxycyclohexyl-(CH₂)ₙ— (where n is an integer from 2 to 20), and the like. Epoxy group containing groups, such as the glycidyloxy-(CH₂)ₙ-group described above are preferable as the cationic polymerization group.

The UV curable functional group represented by R in formula (1) is preferably an epoxy-containing group. Examples of particularly preferable groups include glycidyloxypropyl groups, epoxycyclohexylalkyl groups, and particularly a 3,4-epoxycyclohexylethyl group.

The straight chain, branched, or cyclic organopolysiloxane expressed by the aforementioned average composition formula has at least two UV curable functional groups (R) per molecule on average, wherein the number of UV curable functional groups is preferably 2 to 6, more preferably 2 to 4, especially preferably 2 to 3, and most preferably 2. Two or more different types of UV curable functional groups may be present in one molecule. For example, if two or more epoxy-containing groups are present in one molecule, the groups may be the same or different from each other.

If R′ is a monovalent hydrocarbon group, the monovalent hydrocarbon group may include an unsubstituted monovalent hydrocarbon group and a fluorine-substituted monovalent hydrocarbon group. The unsubstituted or fluorine-substituted monovalent hydrocarbon group is preferably a group selected from unsubstituted or fluorine substituted alkyl, cycloalkyl, arylalkyl, and aryl groups having 1 to 20 carbon atoms. Examples of the alkyl groups above include methyl, ethyl, n-propyl, isopropyl, n-butyl, tert-butyl, sec-butyl, pentyl, octyl, and other groups, and methyl groups are particularly preferable. Examples of the cycloalkyl groups above include cyclopentyl, cyclohexyl, and the like. Examples of the arylalkyl groups above include benzyl, phenylethyl groups, and the like. Examples of the aryl groups above include phenyl groups, naphthyl groups, and the like. Examples of fluorine-substituted monovalent hydrocarbon groups include 3,3,3-trifluoropropyl and 3,3,4,4,5,5,6,6,6-nonafluorohexyl groups. The 3,3,3-trifluoropropyl group is preferred as the fluorine-substituted monovalent hydrocarbon group. If R′ represents an alkoxy group, the number of carbon atoms in the alkoxy group is preferably 1 to 6, more preferably 1 to 3, especially preferably 1 or 2, and most preferably 1. R′ is not a UV curable functional group.

The aforementioned organopolysiloxane expressed by formula (1) has a viscosity at 25° C. of 1 to 1000 mPa·s, 1 to 500 mPa·s, 5 to 100 mPa·s, or 5 to 60 mPa·s, but most preferably 5 to 30 mPa·s. The viscosity of the organopolysiloxane can be adjusted by changing the ratio of a and b in formula (1) as well as the molecular weight.

The organopolysiloxane expressed by formula (1) preferably has on average 2 to 20 silicon atoms per molecule, more preferably 2 to 12, even more preferably 2 to 8, and most preferably 2 to 5 silicon atoms per molecule.

In one preferred aspect, the organopolysiloxane of component (S1-A) is a compound expressed by
the following formula (3):

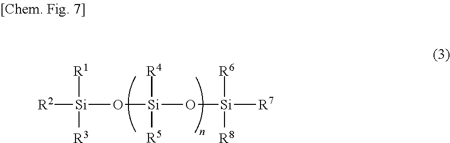

Similar to the aforementioned compound expressed by formula (1) above, the organopolysiloxane expressed by formula (3) has on average two or more UV curable functional groups per molecule. In formula (3), of all R1 to R8 groups, an average of two or more per molecule are UV curable functional groups. The UV curable functional group is an organic group capable of generating a bond between each other by UV irradiation in the presence or absence of a photoinitiator. Examples of the UV curable functional groups can include radical polymerizable groups and cationic polymerizable groups. Radical polymerizable groups are not particularly limited so long as they are a functional group that can form a new bond by a radical reaction mechanism, and particularly a bond between radical polymerizable groups. Examples can include acrylic groups, methacrylic groups, maleimide groups, and organic groups containing any of these groups. Specific examples of the radical polymerizable group include groups such as acryloxypropyl, methacryloxypropyl, acrylamidopropyl, methacrylamidopropyl, 3-(N-maleimido)propyl, and the like. Examples of cationic polymerizable groups include vinyl ether groups, epoxy group-containing groups, oxetane group-containing groups, and other groups, such as CH₂═CH—O—(CH₂)ₙ— (where n is an integer from 3 to 20), glycidyloxy-(CH₂)ₙ— (where n is an integer from 3 to 20), 3,4-epoxycyclohexyl-(CH₂)ₙ— (where n is an integer from 2 to 20), and the like.

One or more types of epoxy group-containing groups are preferred as the UV curable functional group. Examples of particularly preferable groups include 3-glycidyloxypropyl groups, epoxycyclohexylalkyl groups, and particularly a 3,4-epoxycyclohexylethyl group.

In formula (3), R¹ to R⁸ other than the UV curable functional group are each independently an unsubstituted or fluorine-substituted monovalent hydrocarbon group, and preferably a group selected from unsubstituted or fluorine substituted alkyl, cycloalkyl, arylalkyl, and aryl groups having 1 to 20 carbon atoms. Examples of the alkyl groups above include methyl, ethyl, n-propyl, isopropyl, n-butyl, tert-butyl, sec-butyl, pentyl, octyl, and other groups, and methyl groups are particularly preferable. Examples of the cycloalkyl groups above include cyclopentyl, cyclohexyl, and the like. Examples of the arylalkyl groups above include benzyl, phenylethyl groups, and the like. Examples of the aryl groups above include phenyl groups, naphthyl groups, and the like. Examples of fluorine-substituted monovalent hydrocarbon groups include 3,3,3-trifluoropropyl and 3,3,4,4,5,5,6,6,6-nonafluorohexyl groups. The 3,3,3-trifluoropropyl group is preferred as the fluorine-substituted monovalent hydrocarbon group. By introducing a fluorine atom into the organopolysiloxane of formula (3), it may be possible to further reduce the refractive index of a cured product obtained from the composition of the present invention.

The number of UV curable functional groups provided by the organopolysiloxane of formula (3), serving as component (S1-A) is, as a whole, 2 to 6 on average per molecule, preferably 2 to 5, more preferably 2 to 4, particularly preferably 2 to 3, and most preferably 2.

In particular, one of R₁ to R₃ in formula (3) and one of R₆ to R₈ are preferably UV curable functional groups. Furthermore, one of R₁ to R₃ in formula (3) and one of R₆ to R₈ are particularly preferably UV curable functional groups.

For n in formula (3), the viscosity of the organopolysiloxane expressed by formula (3) at 25° C. is preferably 1 to 1000 mPa·s, preferably 1 to 500 mPa·s, more preferably 5 to 100 mPa·s, particularly preferably 5 to 60 mPa·s, and most preferably 5 to 30 mPa·s. A person with ordinary skill in the art can easily determine the value of n without excess trial and error such that the viscosity of the organopolysiloxane of formula (3) is within the aforementioned viscosity range. In general, however, the number of silicon atoms per molecule is preferably 2 to 20, particularly preferably between 2 to 5, in order for the compound of formula (3) to have the desired viscosity.

The organopolysiloxane of formula (3) can be used as one type or as a mixture of two or more types. If two or more organopolysiloxanes are used as a mixture, the viscosity of the mixture at 25° C. is preferably the viscosity described above.

Furthermore, the aforementioned compound of formula (1) above may be an organopolysiloxane expressed by the following average unit formula (4).

### Average Unit Formula:

(R₃SiO_{1/2})ₑ(R₂SiO_{2/2})_{f}(RSiO_{3/2})_{g}(SiO_{4/2})ₕ

In formula (4), R is independently a group selected from UV reactive functional groups, monovalent hydrocarbon groups unsubstituted or substituted with fluorine, at least two of all Rs are UV reactive functional groups, (g+h) is a positive number, e is 0 or a positive number, and f is a number within a range of 0 to 20.

The UV curable functional groups and monovalent hydrocarbon groups are as defined above for formula (1). Furthermore, a preferred viscosity of the organopolysiloxane expressed by formula (4) is as specified above for the organopolysiloxane expressed by formula (1).

The number of UV curable functional groups provided by the organopolysiloxane of formula (4) is preferably 2 to 5, more preferably 2 to 4, particularly preferably 2 to 3, and most preferably 2.

The organopolysiloxane expressed by formula (4) preferably has 2 to 20, especially 2 to 5 silicon atoms per molecule.

Specific examples of the organopolysiloxane having at least two UV curable functional groups per molecule expressed by the aforementioned formula (1), especially formula (3) or formula (4) in particular include:
1,3-bis[2-(3,4-epoxycyclohexyl)ethyl]-1,1,3,3-tetramethyldisiloxane, 1,5-bis[2-(3,4-epoxycyclohexyl)ethyl]-1,1,3,3,5,5-hexamethyltrisiloxane, 1,1,3,3,5,5,7,7,9,9-decamethyl-1,9-bis[2-(3,4-epoxycyclohexyl)ethyl]pentasiloxane, methyl(tris[2-(3,4-epoxycyclohexyl)ethyl]dimethylsiloxy)silane, tetrakis([2-(3,4-epoxycyclohexyl)ethyl]dimethylsiloxy)silane, 1,3-bis(3-glycidoxypropyl)-1 1,3,3-tetramethyldisiloxane, 1,5-bis(3-glycidoxypropyl)-1,1,3,3,5,5-hexamethyltrisiloxane, 1,1,3,3,5,5,7,7,9,9-decamethyl-1,9-bis(3-glycidoxypropyl)pentasiloxane, methyl[tris(3-glycidoxypropyl)dimethylsiloxy]silane, tetrakis[(3-glycidoxypropyl)dimethylsiloxy]silane, double terminated (3,4-epoxycyclohexylethyldimethylsilyl)-polydimethylsiloxane, double terminated (3-glycidoxypropyldimethylsilyl)-polydimethylsiloxane, double terminated trimethylsilyl-dimethylsiloxy/(methyl-3,4-epoxy)cyclohexylethylsiloxy) copolymer, double terminated trimethylsilyl-dimethylsiloxy/(methyl-3-glycidoxypropylsiloxy) copolymer, double terminated (3,4-epoxycyclohexylethyldimethylsilyl)-dimethylsiloxy/(methyl-3,4-epoxycyclohexylethylsiloxy) copolymer, and double terminated (3-glycidoxypropyldimethylsilyl)-dimethylsiloxy/(methyl-3-glycidoxypropylsiloxy) copolymer.

Furthermore, the aforementioned compound of formula (1) may be acyclic organopolysiloxane expressed by formula (5)

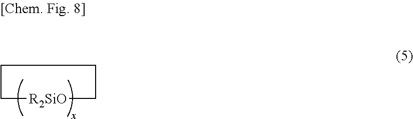

(in formula (5), R is independently a group selected from UV curable functional groups and monovalent hydrocarbon groups unsubstituted or substituted with fluorine, x is an integer of 3 to 10, and at least two UV curable functional groups are provided in a molecule).

The UV curable functional group and the unsubstituted or fluorine-substituted monovalent hydrocarbon group can be represented by R in Formula (5) and are as defined for Formula (1) above.

Furthermore, a preferred viscosity of the organopolysiloxane expressed by formula (5) is as specified above for the organopolysiloxane expressed by formula (1).

Specific examples of the cyclic organopolysiloxane having at least two UV curable functional groups in a molecule expressed by the aforementioned formula (5) include 1,3,5-trimethyl-1,3,5-tri[2-(3,4-epoxycyclohexyl)ethyl]cyclotrisiloxane, 1,3,5-trimethyl-1,3,5-tri(3-glycidoxypropyl)cyclotrisiloxane, 1,3,5,7-tetramethyl-1,3,5,7-tetra[2-(3,4-epoxycyclohexyl]ethyl]cyclotrisiloxane, 1,3,5,7-tetramethyl-1,3,5,7-tetra(3-glycidoxypropyl)cyclotetrasiloxane, 1,3,5,7,9-pentamethyl-1,3,5,7,9-penta[2-(3,4-epoxycyclohexyl)ethyl]cyclopentasiloxane, and 1,3,5,7,9-pentamethyl-1,3,5,7,9-penta(3-glycidoxypropyl)cyclopentasiloxane.

The organopolysiloxane expressed by formulas (1) and (3) to (5) can each be individually one type, or optionally a combination of two or more types as component (S1). Component (S1) is especially preferably one or more organosilicon compound selected from the group consisting of the aforementioned organopolysiloxanes expressed by formula (3), cyclic organopolysiloxanes expressed by formula (5), and combinations thereof.

Component (S1) has a viscosity of 1 to 1000 mPa·s, preferably 1 to 500 mPa·s, 5 to 100 mPa·s, 5 to 60 mPa·s, and preferably 5 to 30 mPa·s at 25ºC for the entire component (S1).

Particularly preferable compounds as component (S1) include one compound or a combination of two or more compound selected from the group consisting of:
1,3-bis[2-(3,4-epoxycyclohexyl)ethyl]-1,1,3,3-tetramethyldisiloxane, 1,5-bis[2-(3,4-epoxycyclohexyl)ethyl]-1,1,3,3,5,5-hexamethyltrisiloxane, 1,1,3,3,5,5,7,7,9,9-decamethyl-1,9-bis[2-(3,4-epoxycyclohexyl)ethyl]pentasiloxane, methyl(tris[2-(3,4-epoxycyclohexyl)ethyl]dimethylsiloxy)silane, tetrakis([2-(3,4-epoxycyclohexyl)ethyl]dimethylsiloxy)silane, 1,3,5,7-tetramethyl-1,3,5,7-tetra[2-(3,4-epoxycyclohexyl)ethyl]-cyclotetrasiloxane, 1,3-bis(3-glycidoxypropyl)-1 1,3,3-tetramethyldisiloxane, 1,5-bis(3-glycidoxypropyl)-1,1,3,3,5,5-hexamethyltrisiloxane, 1,1,3,3,5,5,7,7,9,9-decamethyl-1,9-bis(3-glycidoxypropyl)pentasiloxane, methyl[tris(3-glycidoxypropyl)dimethylsiloxy]silane, tetrakis[(3-glycidoxypropyl)dimethylsiloxy]silane, and 1,3,5,7-tetramethyl-1,3,5,7-tetra(3-glycidoxypropyl)-cyclotetrasiloxane.
   <Component (S1-B): An Organopolysiloxane and/or Organosilane Having One UV Curable Functional Group in a Molecule>

Component (S1-B) is an organosilicon compound having one UV curable functional group in a molecule on an organosilane or organopolysiloxane backbone, and primarily has an effect of controlling crosslinking density of a cured product obtained from the composition of the present invention, adjusting the physical properties of the cured product while simultaneously reducing the viscosity of the composition. A molecular structure thereof can be arbitrary so long as the objective can be achieved. For example, the organosilicon compound of (S1-B) is preferably a straight chain, branched, or cyclic organopolysiloxane or an organosilane expressed by the average composition formula:

R_{c}R′_{d}SiO_{(4-c-d)/}2 (2)
(where in formula (2), R is a UV curable functional group,
R′ is a group selected from monovalent hydrocarbon groups, hydroxyl groups, and alkoxy groups, excluding the UV curable functional group above, and
c and d are numbers that satisfy the following conditions: 1≤c+d≤4 and 0.05≤c/(c+d)≤0.25, and the number of R in the molecule is 1).
   One of these organosilanes and organopolysiloxanes may be used, or any two or more may be used in combination. In this specification, organosilanes and/or organopolysiloxanes are also referred to collectively as organosilicon compounds for simplicity in the following.

The UV curable functional group expressed by R in formula (2) is an organic group capable of generating a bond between each other by UV irradiation in the presence or absence of a photoinitiator. Examples of the UV curable functional groups can include radical polymerizable groups and cationic polymerizable groups. Radical polymerizable groups are not particularly limited so long as they are a functional group that can form a new bond by a radical reaction mechanism, and particularly a bond between radical polymerizable groups. Examples can include acrylic groups, methacrylic groups, maleimide groups, and organic groups containing any of these groups. Specific examples of the radical polymerizable group include groups such as acryloxypropyl, methacryloxypropyl, acrylamidopropyl, methacrylamidopropyl, 3-(N-maleimido)propyl, and the like. Examples of cationic polymerizable groups include vinyl ether groups, epoxy group-containing groups, oxetane group-containing groups, and other groups, such as CH₂═CH—O—(CH₂)ₙ— (where n is an integer from 3 to 20), glycidyloxy-(CH₂)ₙ— (where n is an integer from 3 to 20), 3,4-epoxycyclohexyl-(CH₂)ₙ— (where n is an integer from 2 to 20), and the like.

The UV curable functional group represented by R in formula (2) is preferably an epoxy-containing group. Examples of particularly preferable groups include glycidyloxypropyl groups, epoxycyclohexylalkyl groups, and particularly a 3,4-epoxycyclohexylethyl group. The organosilicon compound expressed by the aforementioned average composition formula (2) has one UV curable functional group (R) in a molecule.

If R′ in formula (2) is a monovalent hydrocarbon group, each monovalent hydrocarbon group is independently a group selected from the group consisting of unsubstituted monovalent hydrocarbon groups and fluorine-substituted monovalent hydrocarbon groups. The unsubstituted or fluorine-substituted monovalent hydrocarbon group is preferably a group selected from unsubstituted or fluorine substituted alkyl, cycloalkyl, arylalkyl, and aryl groups having 1 to 20 carbon atoms. Examples of the alkyl groups above include methyl, ethyl, n-propyl, isopropyl, n-butyl, tert-butyl, sec-butyl, pentyl, octyl, and other groups, and methyl groups are particularly preferable. Examples of the cycloalkyl groups above include cyclopentyl, cyclohexyl, and the like. Examples of the arylalkyl groups above include benzyl, phenylethyl groups, and the like. Examples of the aryl groups above include phenyl groups, naphthyl groups, and the like. Examples of fluorine-substituted monovalent hydrocarbon groups include 3,3,3-trifluoropropyl and 3,3,4,4,5,5,6,6,6-nonafluorohexyl groups. The 3,3,3-trifluoropropyl group is preferred as the fluorine-substituted monovalent hydrocarbon group. By introducing a fluorine atom into the organopolysiloxane of formula (2), it may be possible to further reduce the refractive index of a cured product obtained from the curable composition of the present invention.

The viscosity of the organosilicon compound expressed by the aforementioned formula (2) at 25° C. is 1 to 1000 mPa·s, preferably 1 to 500 mPa·s, more preferably 1 to 100 mPa·s, and particularly preferably 1 to 50 mPa·s. The viscosity of the organosilicon compound can be adjusted by changing the ratio and the molecular weight of c and d in formula (2).

The aforementioned organosilicon compound expressed by formula (2) is preferably a compound having 1 to 20, preferably 1 to 4, silicon atoms per molecule.

In one preferred aspect, the organosilicon compound having one UV curable functional group in a molecule of component (S1-B) is an organopolysiloxane compound expressed by the following formula (3′):

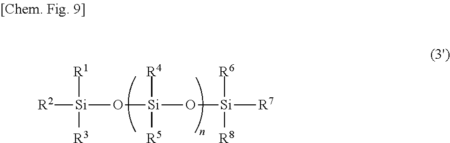

Similar to the aforementioned compound expressed by formula (2) above, in the organopolysiloxane expressed by formula (3′), only one of all R¹ to R⁸ is a UV curable functional group. Therefore, the organopolysiloxane expressed by formula (3′) has one UV curable functional group per molecule.

Similar to the aforementioned compound expressed by formula (2) above, the UV curable functional group in formula (3′) is an organic group capable of generating a bond between each other by UV irradiation in the presence or absence of a photoinitiator. Examples of the UV curable functional groups can include radical polymerizable groups and cationic polymerizable groups. Radical polymerizable groups are not particularly limited so long as they are a functional group that can form a new bond by a radical reaction mechanism, and particularly a bond between radical polymerizable groups. Examples can include acrylic groups, methacrylic groups, maleimide groups, and organic groups containing any of these groups. Specific examples of the radical polymerizable group include groups such as acryloxypropyl, methacryloxypropyl, acrylamidopropyl, methacrylamidopropyl, 3-(N-maleimido)propyl, and the like. Examples of cationic polymerizable groups include vinyl ether groups, epoxy group-containing groups, oxetane group-containing groups, and other groups, such as CH₂═CH—O—(CH₂)ₙ— (where n is an integer from 3 to 20), glycidyloxy-(CH₂)ₙ— (where n is an integer from 3 to 20), 3,4-epoxycyclohexyl-(CH₂)ₙ— (where n is an integer from 2 to 20), and the like.

The UV curable functional group is preferably one or more types of epoxy group-containing group. Examples of particularly preferable groups include glycidyloxypropyl groups, epoxycyclohexylalkyl groups, and particularly a 3,4-epoxycyclohexylethyl group.

In formula (3′), R¹ to R⁸ other than the UV curable functional group are each independently an unsubstituted or fluorine-substituted monovalent hydrocarbon group, and preferably a group selected from unsubstituted or fluorine substituted alkyl, cycloalkyl, arylalkyl, and aryl groups having 1 to 20 carbon atoms. Examples of the alkyl groups above include methyl, ethyl, n-propyl, isopropyl, n-butyl, tert-butyl, sec-butyl, pentyl, octyl, and other groups, and methyl groups are particularly preferable. Examples of the cycloalkyl groups above include cyclopentyl, cyclohexyl, and the like. Examples of the arylalkyl groups above include benzyl, phenylethyl groups, and the like. Examples of the aryl groups above include phenyl groups, naphthyl groups, and the like. Examples of fluorine-substituted monovalent hydrocarbon groups include 3,3,3-trifluoropropyl and 3,3,4,4,5,5,6,6,6-nonafluorohexyl groups. The 3,3,3-trifluoropropyl group is preferred as the fluorine-substituted monovalent hydrocarbon group. By introducing a fluorine atom into the organopolysiloxane of formula (3′), it may be possible to further reduce the refractive index of a cured product obtained from the composition of the present invention.

There is no limitation to the position of the UV curable functional group in the organopolysiloxane expressed by formula (3′), and a molecular end group, in other words, one of R₁ to R₃ or one of R₆ to R₈ may be a UV curable functional group. Moreover, a non-terminal group, in other words, one of R₄ and R₅ in formula (3′) can be a UV curable functional group.

For n in formula (3′), the viscosity of the organopolysiloxane expressed by formula (3′) above at 25° ° C. is preferably 1 to 1000 mPa·s, preferably 1 to 500 mPa·s, more preferably 1 to 100 mPa·s, and particularly preferably 1 to 50 mPa·s. A person with ordinary skill in the art can easily determine the value of n without excess trial and error such that the viscosity of the organopolysiloxane of formula (3′) is within the aforementioned viscosity range. In general, the number of silicon atoms per molecule is preferably 2 to 20, particularly preferably between 2 to 5, in order for the compound of formula (3′) to have the desired viscosity.

The organopolysiloxane of formula (3′) can be used as one type or as a mixture of two or more types. If a mixture of two or more organopolysiloxanes are used as a mixture, the viscosity of the mixture at 25° C. is 1 to 1000 mPa·s, preferably 1 to 500 mPa·s, more preferably 1 to 100 mPa·s, particularly preferably 1 to 50 mPa·s, and particularly 5 to 20 mPa·s.

Specific examples of organopolysiloxanes having one UV curable functional group er molecule expressed by Formula (3′) include 1-[2-(3,4-epoxycyclohexyl)ethyl]-1,1,3,3,3-pentamethyldisiloxane, 1-[2-(3,4-epoxycyclohexyl)ethyl]-1,1,3,3,5,5,5-heptamethyltrisiloxane, 3-[2-(3,4-epoxycyclohexyl)ethyl]-1,1,1,3,5,5,5-heptamethyltrisiloxane, and 1-[2-(3,4-epoxycyclohexyl)ethyl]-1,1,3,3,5,5,7,7,7-nonamethyltetrasiloxane, 1-(3-glycidoxypropyl)-1,1,3,3,3-pentamethyldisiloxane, 1-(3-glycidoxypropyl)-1,1,1,3,3,5,5,5-heptamethyltrisiloxane, 3-(3-glycidoxypropyl)-1,1,1,3,5,5,5-heptamethyltrisiloxane, and 1-(3-glycidoxypropyl)-1,1,3,3,5,5,7,7,7-nonamethyltetrasiloxane.

Furthermore, the aforementioned organosilicon compound of formula (2) above may be a cyclic organopolysiloxane expressed by the following formula (5′).

### Formula:

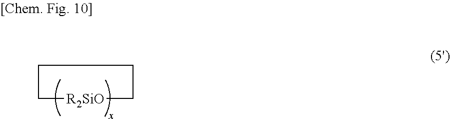

In formula (5′), R is independently a group selected from UV curable functional groups and monovalent hydrocarbon groups unsubstituted or substituted with fluorine, x is an integer of 3 to 5, and only one UV curable functional group is provided in a molecule.

The UV curable functional groups and monovalent hydrocarbon groups are as defined above for the aforementioned formula (2).

A preferred viscosity of the cyclic organopolysiloxane expressed by formula (5′) is as specified above for the organopolysiloxane expressed by formula (2). Therefore, the viscosity at 25° C. is 1 to 1000 mPa·s, preferably 1 to 500 mPa·s, more preferably 1 to 100 mPa·s, and particularly preferably 1 to 50 mPa·s.

Specific examples of the cyclic organopolysiloxanes expressed by formula (5′) include [2-(3,4-epoxycyclohexyl)ethyl]-pentamethylcyclotrisiloxane, [2-(3,4-epoxycyclohexyl)ethyl]-heptamethylcyclotetrasiloxane, [2-(3,4-epoxycyclohexyl)ethyl]-nonamethylcyclopentasiloxane, 3-glycidoxypropyl-pentamethylcyclotrisiloxane, 3-glycidoxypropyl-heptamethylcyclotetrasiloxane, and 3-glycidoxypropyl-nonamethylcyclopentasiloxane.

Furthermore, component (S1-B) may be an organosilane expressed by the following formula (6).

RSiR′₃ Formula: (6)

In formula (6), R is a UV curable functional group, and R′ is a group selected from monovalent hydrocarbon groups, hydroxyl groups, and alkoxy groups excluding the UV curable functional group.

The UV curable functional group and monovalent hydrocarbon group are as defined for the aforementioned formula (2) above, and alkoxy group is an alkoxy group with 1 to 20 carbon atoms, preferably 1 to 6 carbon atoms, and more preferably 1 to 3 carbon atoms, or a cycloalkyl group with 5 to 20 carbon atoms. Specifically, a methoxy group, ethoxy group, isopropoxy group, cyclopentyl group, or cyclohexyl group is preferred.

Furthermore, a preferred viscosity of the organosilane expressed by formula (6) is the same as the aforementioned viscosity specified for the organopolysiloxane expressed by formula (2). Therefore, the viscosity at 25° C. is 1 to 1000 mPa·s, preferably 1 to 500 mPa·s, more preferably 1 to 100 mPa·s, and particularly preferably 1 to 50 mPa·s.

Specific examples of organosilanes expressed by formula (6) include [2-(3,4-epoxycyclohexyl)ethyl]triethylsilane, [2-(3,4-epoxycyclohexyl)ethyl]dimethylphenylsilane, [2-(3,4-epoxycyclohexyl)ethyl]dimethyloctylsilane, [2-(3,4-epoxycyclohexyl)ethyl]dimethylcyclohexylsilane, [2-(3,4-epoxycyclohexyl)ethyl]trihexylsilane, [2-(3,4-epoxycyclohexyl)ethyl]tributylsilane, 3-glycidoxypropyltriethylsilane, 3-glycidoxypropyl dimethylphenylsilane, 3-glycidoxypropyl dimethyloctylsilane, 3-glycidoxypropyl dimethylcyclohexylsilane, 3-glycidoxypropyl trihexylsilane, and 3-glycidoxypropyl tributylsilane.

The organosilicon compounds expressed by formulas (2), (3′), (5′), and (6) can be used individually or optionally in a combination of two or more types. In other words, the organosilicon compounds expressed by formula (2), (3′), (5′), or (6), and mixtures of two or more compounds arbitrarily selected therefrom can be used as component (S1-B) of the composition of the present invention.

Component (S1-B) is preferably an organosilicon compound selected from organopolysiloxanes expressed by formula (3′), cyclic organopolysiloxanes expressed by formula (5′), organosilanes expressed by formula (6), and arbitrary combinations thereof.

Component (S1-B) is particularly preferably 1,1,1,3,5,5,5-heptamethyl-3-[2-(3,4-epoxycyclohexyl)ethyl]trisiloxane.

Compound (S1) can be only the aforementioned component (S1-A) or only component (S1-B), or a combination of the aforementioned component (S1-A) and component (S1-B), and the mass ratio of component (S1-A), and component (S1-B) may be an arbitrary mass ratio in the range of 100/0 to 0/100 (S1-A/S1-B), but the ratio of component (S1-B) is preferably 10% by mass or more, more preferably 20% by mass or more, and particularly preferably 30% by mass or more, with regard to a total of 100% by mass of component (S1-A) and component (S1-B).

When component (S1-A), and component (S1-B) are used in combination as component (S1), component (S1-A) can be one compound or a combination of two or more compounds selected from the group consisting of:
1,3-bis[2-(3,4-epoxycyclohexyl)ethyl]-1,1,3,3-tetramethyldisiloxane, 1,5-bis[2-(3,4-epoxycyclohexyl)ethyl]-1,1,3,3,5,5-hexamethyltrisiloxane, 1,1,3,3,5,5,7,7,9,9-decamethyl-1,9-bis[2-(3,4-epoxycyclohexyl)ethyl]pentasiloxane, methyl(tris[2-(3,4-epoxycyclohexyl)ethyl]dimethylsiloxy)silane, tetrakis([2-(3,4-epoxycyclohexyl)ethyl]dimethylsiloxy)silane, 1,3,5,7-tetramethyl-1,3,5,7-tetra[2-(3,4-epoxycyclohexyl)ethyl]-cyclotetrasiloxane, 1,3-bis(3-glycidoxypropyl)-1 1,3,3-tetramethyldisiloxane, 1,5-bis(3-glycidoxypropyl)-1,1,3,3,5,5-hexamethyltrisiloxane, 1,1,3,3,5,5,7,7,9,9-decamethyl-1,9-bis(3-glycidoxypropyl)pentasiloxane, methyl[tris(3-glycidoxypropyl)dimethylsiloxy]silane, tetrakis[(3-glycidoxypropyl)dimethylsiloxy]silane, and 1,3,5,7-tetramethyl-1,3,5,7-tetra(3-glycidoxypropyl)-cyclotetrasiloxane; and 1,1,1,3,5,5,5-heptamethyl-3-[2-(3,4-epoxycyclohexyl)ethyl]trisiloxane is preferably used in combination as component (S1-B), and the mass ratio of component (S1-B) to component (S1-A) is preferably 100/0 to 20/80 (S1-B/S1-A), more preferably 100/0 to 25/75, and especially preferably in a range of 100/0 to 30/70. However, the mass ratio of the aforementioned component (S1-A) to component (S1-B) is a value that defines a particularly preferable range, and the curable composition of the present invention can also be prepared using only component (S1-A). Therefore, the mass ratio of component (S1-B) to component (S1-A) may be 100/0 to 0/100.

If the curable composition of the present invention contains 1,1,1,3,5,5,5-heptamethyl-3-[2-(3,4-epoxycyclohexyl)ethyl]trisiloxane, which corresponds to (S1-B) as component (S1), the amount is preferably in a range of 20 to 100% of the total mass of the curable composition, preferably 25 to 95%, more preferably 30 to 95%.

When components (S1-A) and (S1-B) are used together as component (S1), the UV curable functional group of component (S1-A) and the UV curable functional group of component (S1-B) are preferably the same type of UV curable functional group. Therefore, if the UV curable functional group of component (S1-A) is a radical polymerizable group, the UV curable functional group of component (S1-B) is also preferably a radical polymerizable group. Furthermore, if the UV curable functional group of component (S1-A) is a cation polymerizable group, the UV curable functional group of component (S1-B) is also preferably a cation polymerizable group. Particularly preferably, both components (S1-A) and (S1-B) have epoxy-containing groups as the UV curable functional group.

Therefore, in one preferable aspect of the present invention, component (S1) a mixture containing:
(S1-1) one or more organopolysiloxanes having on average two or more epoxy-containing groups per molecule; and
(S1-2) one or more organosilicon compound selected from the group consisting of organopolysiloxanes and/or organosilanes having one epoxy group-containing group per molecule,
   such that the mass ratio (S1-1/S1-2) of component (S1-1) and component (S1-2) is 100/0 to 0/100. In this case, organopolysiloxanes with an average of two or one epoxy-containing group per molecule can be selected from those mentioned above.

### <Optional Component (D): Compound Having One or More UV Curable Functional Groups in One Molecule and No Silicon Atoms>

In addition to the aforementioned component (S1), or in other words component (S1-A) and/or component (S1-B), a compound having one or more UV curable functional groups in one molecule and not having a silicon atom (component (D)) may be further added to the curable composition of the present invention. In particular, when only component (S1-B) is used as component (S1), component (D) is preferably used in addition to component (S1-B). The curability of the composition may be improved by using component (D) in combination with component (S1-B).

The UV curable functional groups of component (D) can be the same as those listed in connection with components (S1), (S1-A), and (S1-B). The difference between component (D) and components (S1), (S1-A), and (S1-B) is that the latter components have a silicon atom in the molecule, while component (D) does not have a silicon atom in the molecule. Any compound that does not contain a silicon atom in the molecule but has one or more of the aforementioned UV curable functional groups in the molecule can be used as component (D), with no particular limitation on the chemical structure.

If the UV curable reactive group of component (S1), or in other words components (S1-A) and/or (S1-B) has an epoxy group-containing group that is a cation polymerizable group, component (D) can be an organic compound that has an epoxy group in the molecule, especially a compound that has an epoxy group and which does not have a cyclic structure. Preferred specific examples of component (D) include 2-ethylhexyl glycidyl ether, glycidyl lauryl ether, ethylene glycol diglycidyl ether, 1,4-butanediol diglycidyl ether, neopentyl glycol diglycidyl ether, 1,2-epoxydecane, 1,2-epoxydododecane, and 1,7-octadiene diepoxide, but are not limited to these. 1,2-epoxydodecane, 1,7-octadiene diepoxide, and 1,4-butanediol diglycidyl ether are particularly preferred as component (D).

The viscosity of component (D) at 25° C. is preferably 1 to 1000 mPa·s, especially 1 to 500 mPa·s, more preferably 1 to 100 mPa·s, especially 1 to 50 mPa·s, and most preferably 1 to 20 mPa·s.

When component (D) is used in addition to the aforementioned components (S1-A) and/or (S1-B), the mass ratio of component (D) to the total amount of components (S1-A), (S1-B), and (D) in the curable composition is less than 20%, preferably less than 10%, and especially preferably less than 5%.

In one preferred aspect of the UV curable composition of the present invention, component (S1) is included as component (S), or component (S1) is the main component of component (S). In such a case, the ratio of component (S1) to the total mass of the curable composition is preferably 90% by mass or more, and even more preferably 95% by mass or more. By using component (S1) in such an amount, the chemical stability of the polysiloxane can be used to obtain a cured product with high stability.

If the aforementioned component (S1) is used as component (S) in the UV curable composition of the present invention, a photoinitiator can be added if desired, in addition to component (S1). If the UV curable functional group provided by component (S1) is a cationic polymerizable functional group containing an epoxy-containing group, vinylether group, or the like, a photocationic polymerization initiator is used as the photopolymerization initiator. Well known photocationic polymerization initiators include compounds that can generate Bronsted acids or Lewis acids by UV or electron beam irradiation, and are so-called photoacid generators, and it is known that irradiation of ultraviolet rays or the like generates an acid, which causes a reaction between cationic polymerizable functional groups. Furthermore, when the UV curable functional group is a radical polymerizable functional group, a photoradical polymerization initiator can be used as the photopolymerization initiator. The photoradical polymerization initiator generates free radicals by irradiating ultraviolet rays or electron beams, which trigger a radical polymerization reaction, to cure the composition of the present invention. The radical polymerization initiator will be described in detail later in connection with the use of component (S2) as component (S).

In an aspect in which component (S1) is used as component (S), the UV curable functional group is a cation polymerizable functional group, and preferably a photocationic polymerization initiator is used, and particularly preferably a photoacid generator is used as the photoinitiator. When the composition of the present invention is cured by electron beam irradiation, a polymerization initiator is normally not required.

### [Photocationic Polymerization Initiator]

The photocationic polymerization initiator used in the UV curable composition of the present invention can be selected from any photocationic polymerization initiator known in the technical field and is not limited to any particular one. Strong acid generating compounds, such as diazonium salts, sulfonium salts, iodonium salts, phosphonium salts, and the like, are known as photocationic polymerization initiators, and these can be used. Examples of photocationic polymerization initiators include, but are not limited to, bis(4-tert-butylphenyl)iodonium hexafluorophosphate, cyclopropyldiphenylsulfonium tetrafluoroborate, dimethylphenacylsulfonium tetrafluoroborate, diphenyliodonium hexafluorophosphate, diphenyliodonium hexafluoroarsenate, diphenyliodonium tetrafluoromethanesulfonate, 2-(3,4-dimethoxystyryl)-4,6-bis(trichloromethyl)-1,3,5-triazine, 2-[2-(furan-2-yl)vinyl]-4,6-bis(trichloromethyl)-1,3,5-triazine, 4-isopropyl-4′-methyldiphenyliodonium tetrakis(pentafluorophenyl)borate, 2-[2-(5-methylfuran-2-yl)vinyl]-4,6-bis(trichloromethyl)-1,3,5-triazine, 2-(4-methoxyphenyl)-4,6-bis(trichloromethyl)-1,3,5-triazine, 2-(4-methoxystylyl)-4,6-bis(trichloromethyl)-1,3,5-triazine, 4-nitrobenzenediazonium tetrafluoroborate, triphenylsulfonium tetrafluoroborate, triphenylsulfonium bromide, tri-p-tolylsulfonium hexafluorophosphate, tri-p-tolylsulfonium trifluoromethanesulfonate, diphenyliodonium triflate, triphenylsulfonium triflate, diphenyliodonium nitrate, bis(4-tert-butylphenyl)iodonium perfluoro-1-butane sulfonate, bis(4-tert-butylphenyl)iodonium triflate, triphenylsulfonium perfluoro-1-butanesulfonate, N-hydroxynaphthalimide triflate, p-toluene sulfonate, diphenyliodonium p-toluenesulfonate, (4-tert-butylphenyl) diphenylsulfonium triflate, tris(4-tert-butylphenyl)sulfonium triflate, N-hydroxy-5-norbornene-2,3-dicarboxymide perfluoro-1-butanesulfonate, (4-phenylthiophenyl) diphenylsulfonium triflate, 4-(phenylthio) phenyldiphenylsulfonium triethyltrifluorophosphate, and the like. In addition to the aforementioned compounds, examples of photocationic polymerization initiators can include Omnicat 250, Omnicat 270 (produced by IGM Resins B.V.), CPI-310B, IK-1 (produced by San-Apro Ltd.), DTS-200 (produced by Midori Kagaku Co., Ltd.), and Irgacure 290 (produced by BASF), and other commercially available photoinitiators.

The amount of the photocationic polymerization initiator added to the UV curable composition of the present invention is not particularly limited so long as a desired photo-curing reaction occurs, but in general, the photocationic polymerization initiator is used in an amount of 0.1 to 10% by mass, preferably 0.2 to 5% by mass, particularly preferably 0.5 to 4% by mass, relative to the total amount of the UV curable composition of the present invention.

Moreover, a photosensitizer may be used in combination with the aforementioned photocationic polymerization initiator. Use of a sensitizer can increase the photon efficiency of the polymerization reaction, and is particularly effective when the coating thickness of the composition is relatively thick or when a relatively long-wavelength LED light source is used, because use of longer wavelength light for the polymerization reaction compared to only using a photopolymerization initiator is feasible. While not limited thereto, exemplary known sensitizers include anthracene based compounds, phenothiazine based compounds, perylene based compounds, cyanine based compounds, melocyanine based compounds, coumarin based compounds, benzylidene ketone based compounds, and (thio)xanthene or (thio)xanthone based compounds such as isopropylthioxanthone, 2,4-diethylthioxanthone, alkyl-substituted anthracenes, squarylium based compounds, (thia)pyrylium based compounds, porphyrin based compounds, etc., with any photosensitizer capable of being used in the curable composition according to the present invention.

### [Component (S2)]

Component (S2) a mixture containing (A) a compound with a UV curable functional group, with or without a silicon atom, and (B) an organopolysiloxane without a UV curable functional group, at a mass ratio of 5:95 to 95:5 (A:B).

<Component (A): Compound with UV Curable Functional Group and with a Silicon Atom or without a Silicon Atom>

Therefore, component (A) is (A1) a compound having a UV curable functional group and a silicon atom, (A2) a compound having a UV curable functional group but without a silicon atom, or a combination of (A1) and (A2), and in each case, the compounds of (A1) and (A2) are one type or a combination of 2 or more compounds.

<Component (A1): Compound with a UV Curable Functional Group and a Silicon Atom>

Component (A1) is a compound having a UV curable functional group and a silicon atom. The compound of component (A1) is a compound selected from the group consisting of component (S1), (S1-A), (S1-B), (S-1), and (S1-2) described above, or a mixture of two or more compounds. In addition to the type of view the curable functional group, a preferable form of component (S1), for example, the preferable viscosity can be determined by using a preferable number of UV curable functional groups per molecule or the like in component (A1).

Radical polymerizable groups and cationic polymerizable groups can be suggested as the UV curable functional groups of component (A1), but radical polymerizable groups, especially acryloxy groups, are preferable. Organopolysiloxanes and/or organosilanes having one or more acryloxy groups per molecule are particularly preferred as the compound of component (A1). Specific examples include single terminated acryloxy-functional polydimethylsiloxane, single terminated acryloxy-functional polydimethyldiphenylsiloxane copolymer, double terminated acryloxy-functional polydimethylsiloxane, double terminated acryloxy-functional polydimethyldiphenylsiloxane copolymer, double terminated trimethylsilyl-functional polydimethyl(acryloxyalkylmethyl)siloxane copolymer, double terminated acryloxy-functional polydimethyl(acryloxyalkylmethyl)siloxane copolymer, and the like, which may be used alone or in a mixture of two or more types. There are no restrictions on the molecular weight or molecular weight distribution, as long as the viscosity falls within the preferred viscosity range described above.

<Component (A2): Compound with a UV Curable Functional Group but without a Silicon Atom>

Component (A2) is a compound having a UV curable functional group but without a silicon atom in the molecule. The UV curable functional group of component (A2) is an organic group capable of generating a bond between each other by UV irradiation in the presence or absence of a photoinitiator, similar to the UV curable functional group of component (S1). Radical polymerizable groups and cationic polymerizable groups can be suggested as an example of a UV curable functional group, but radical polymerizable groups, especially acryloxy groups, are preferable. The radical polymerizable groups can be those described in connection with component (S1). Specifically, compounds with one or more acryloxy groups per molecule are preferred. There is no restriction on the molecular structure as long as the object of the present invention can be achieved, and the structure can be straight-chain, branched, cyclic, box-shaped, or any other type.

The viscosity of component (A2) at 25° C. is preferably 1 to 1000 mPa·s, especially 1 to 500 mPa·s, more preferably 1 to 100 mPa·s, especially 1 to 20 mPa·s, and most preferably 1 to 10 mPa·s.

Furthermore, the aforementioned component (A2) is preferably a compound containing 1 to 4 acryloxy groups per molecule, preferably 1 to 3 groups, and even more preferably 1 to 2 groups. In compounds with a plurality of acryloxy groups, there is no restriction on the positions of the acryloxy groups in the molecule, and the groups can be close together or far apart.

The aforementioned component (A2) may be a single compound having one acryloxy group or a mixture of two or more compounds, each having one acryloxy group.

Furthermore, the aforementioned component (A2) may be a mixture of one or more compound having one acryloxy group and one or more compound having two or more acryloxy groups.

Specific examples of compounds with one acryloxy group include isoamyl acrylate, octyl acrylate, lauryl acrylate, stearyl acrylate, diethylene glycol monoethyl ether acrylate, diethylene glycol monomethyl ether acrylate, 2-ethylhexyl acrylate, phenoxyethyl acrylate, diethylene glycol monophenyl ether acrylate, 4-hydroxybutyl acrylate, 2-hydroxypropyl acrylate, tetrahydrofurfuryl acrylate, isobornyl acrylate, dicyclopentanyl acrylate, dicyclopentenyl acrylate, 3,3,5-tricyclohexyl acrylate, and the like, which may be used individually, or in mixtures of two or more.

Compounds with one acryloxy group can be used individually, or in combinations of two or more groups, taking into consideration the viscosity of the compound, curing properties, hardness of the composition after curing, and the glass transition temperature. Of these, use of one or a combination of two or more compounds selected from 2-ethylhexyl acrylate, isobornyl acrylate, and dicyclopentanyl acrylate is preferable.

Specific examples of compounds having two or more acryloxy groups include diethylene glycol diacrylate, triethylene glycol diacrylate, neopentyl glycol diacrylate, polyethylene glycol diacrylate, 1,4-bis(acryloyloxy)butane, 1,6-bis(acryloyloxy)hexane, 1,9-bis(acryloyloxy)nonane, trimethylolpropane triacrylate, tris(2-acryloyloxy)ethyl isoacrylate, and pentaerythritol tetraacrylate.

Compounds with two or more acryloxy groups can be used individually, or in combinations of two or more groups, taking into consideration the viscosity of the compound, curing properties, compatibility with the aforementioned compounds having one acryloxy group, hardness of the composition after curing, and the glass transition temperature. One or a combination of two or more compounds selected from the group consisting of diethylene glycol diacrylate, 1,6-bis(acryloyloxy)hexane, and trimethylolpropane triacrylate is preferably used.

Furthermore, in consideration of the aforementioned properties, these compounds having two or more acryloxy groups can be used in combination with the compounds having one acryloxy group. In this case, both can be combined in any ratio, but usually the ratio of [compounds with two or more acryloxy groups]/[compounds with one acryloxy group] ranges from 1/99 to 50/50 (mass ratio). This is because if the ratio of compounds with two or more acryloxy groups is too high, the cured material will tend to be hard and brittle.

Either one or a combination of component (A1) and component (A2) can be used. In the case where components (A1) and (A2) are used in combination, if a combination of compounds having two or more acryloxy groups and compounds having one acryloxy group is used, the compounds may be combined in any ratio, but the ratio of [compounds having two or more acryloxy groups]/[compounds having one acryloxy group] is preferably in a range of 1/99 to 50/50 (mass ratio).

In one preferred aspect of the present invention, only component (A2) is used as component (A), which is combined with component (B) to make component (S) of the curable composition of the present invention.

### <Component (B): Organopolysiloxane Without UV Curable Functional Group>

Component (B) is an organopolysiloxane without a UV curable functional group. Particularly preferably, component (B) is one or more type of alkenyl group-containing organopolysiloxane selected from the following (B1) and (B2):
(B1) organopolysiloxane having three or more alkenyl groups in one molecule and no UV curable functional groups;
(B2) organopolysiloxane having two or more alkenyl groups in one molecule but not having a UV curable functional group, where the amount of vinyl groups is 5% or more by mass. The alkenyl groups are preferably terminal alkenyl groups. Note that the amount of vinyl groups refers to the ratio of the mass of the vinyl group portion (CH₂═CH—) of all alkenyl groups included in the compound to the mass of the entire molecule.

The aforementioned component (B) can be a straight-chain, branched, or cyclic alkenyl-containing organopolysiloxane expressed by the average composition formula:

RₐR′_{b}SiO_{(4-a-b)/2} (7)
(In formula (7), R is an alkenyl group;
R′ is a group selected from monovalent hydrocarbon groups excluding alkenyl groups, hydroxyl groups, and alkoxy groups;
a and b are numbers that satisfy the following conditions: 1≤a+b<3 and 0.1≤a/(a+b)≤1.0, and at least two alkenyl groups (R) are present in the molecule.)

The aforementioned straight chain, branched, or cyclic organopolysiloxane expressed by the average composition formula (7) has at least two alkenyl groups (R) in a molecule, or in other words, per molecule on average, but the number of alkenyl groups is preferably 3 to 10, more preferably 3 to 8, and especially preferably 4 to 8 per molecule on average.

Examples of the alkenyl groups represented by R in formula (7) include alkenyl groups with 2 to 8 carbon atoms, especially alkenyl groups with terminal double bonds, and specifically vinyl, allyl, butenyl, pentenyl, hexenyl, and octenyl groups. Hexenyl groups are particularly preferable.

R′ in formula (7) is a group selected from monovalent hydrocarbon groups, hydroxyl groups, and alkoxy groups, excluding alkenyl groups, or in other words is not an alkenyl group, and monovalent hydrocarbon groups include unsubstituted monovalent hydrocarbon groups and fluorine-substituted monovalent hydrocarbon groups. The unsubstituted or fluorine-substituted monovalent hydrocarbon group is preferably a group selected from unsubstituted or fluorine substituted alkyl, cycloalkyl, arylalkyl, and aryl groups having 1 to 20 carbon atoms. Examples of the alkyl groups above include methyl, ethyl, n-propyl, isopropyl, n-butyl, tert-butyl, sec-butyl, pentyl, hexyl, octyl, and other groups, but methyl groups and hexyl groups are particularly preferable. Examples of the cycloalkyl groups above include cyclopentyl, cyclohexyl, and the like. Examples of the arylalkyl groups above include benzyl, phenylethyl groups, and the like. Examples of the aryl groups above include phenyl groups, naphthyl groups, and the like. Examples of fluorine-substituted monovalent hydrocarbon groups include 3,3,3-trifluoropropyl and 3,3,4,4,5,5,5,6,6,6-nonafluorohexyl groups. The 3,3,3-trifluoropropyl group is preferred as the fluorine-substituted monovalent hydrocarbon group.

The aforementioned organopolysiloxane expressed by formula (7) has a viscosity at 25° C. of 1 to 1000 mPa·s, preferably 5 to 500 mPa·s, but most preferably 5 to 200 mPa·s. The viscosity of the organopolysiloxane can be adjusted by changing the ratio of a and b in formula (1) as well as the molecular weight.

The organopolysiloxane expressed by formula (7) preferably has on average 3 to 50 silicon atoms per molecule, more preferably 4 to 20 atoms, and even more preferably 4 to 10 atoms.

In one preferred aspect, the organopolysiloxane of component (B) is a compound expressed by the following formula (8).

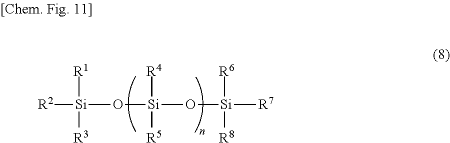

Similar to the aforementioned compound expressed by formula (7), the organopolysiloxane expressed by formula (8) has on average two or more alkenyl groups per molecule. In formula (8), of all R¹ to R⁸ groups, an average of two or more per molecule are alkenyl groups. The structure of the alkenyl group is not limited to an alkenyl group with a specific chemical structure as long as the structure has a carbon-carbon double bond. The alkenyl group is particularly preferably a terminal alkenyl group, and examples include alkenyl groups with 2 to 20 carbon atoms, such as vinyl groups, allyl groups, butenyl groups, pentenyl groups, hexenyl groups, heptenyl groups, octenyl groups, nonenyl groups, decenyl groups, undecenyl groups, dodecenyl groups, 4-vinylphenyl groups, and the like, but this is not a limitation. The alkenyl-containing group is particularly preferably a group selected from vinyl groups, allyl groups, hexenyl groups, and octenyl groups, but allyl groups and hexenyl group are particularly preferable.

R¹ to R⁸ in formula (8) are not UV curable functional groups, and each independently is a group selected from an unsubstituted or fluorine-substituted monovalent hydrocarbon group, preferably a group selected from unsubstituted or fluorine-substituted alkyl, cycloalkyl, arylalkyl, and aryl groups having 1 to 20 carbon atoms. Examples of the alkyl groups above include methyl, ethyl, n-propyl, isopropyl, n-butyl, tert-butyl, sec-butyl, pentyl, octyl, and other groups, and methyl groups are particularly preferable. Examples of the cycloalkyl groups above include cyclopentyl, cyclohexyl, and the like. Examples of the arylalkyl groups above include benzyl, phenylethyl groups, and the like. Examples of the aryl groups above include phenyl groups, naphthyl groups, and the like. Examples of fluorine-substituted monovalent hydrocarbon groups include 3,3,3-trifluoropropyl and 3,3,4,4,5,5,5,6,6,6-nonafluorohexyl groups. The 3,3,3-trifluoropropyl group is preferred as the fluorine-substituted monovalent hydrocarbon group.

For n in formula (8), the viscosity of the organopolysiloxane expressed by formula (8) at 25° C. is preferably 1 to 1000 mPa·s, more preferably 5 to 500 mPa·s, particularly preferably 5 to 100 mPa·s. A person with ordinary skill in the art can easily determine the value of n without excess trial and error such that the viscosity of the organopolysiloxane of formula (8) is within the aforementioned viscosity range. In general, however, the number of silicon atoms per molecule is preferably 3 to 150, particularly preferably between 3 to 50, in order for the compound of formula (8) to have the desired viscosity.

The number of alkenyl groups provided by the organopolysiloxane of formula (8), serving as component (B) is preferably, as a whole, 2 to 10 on average per molecule, more preferably 3 to 10, particularly preferably 3 to 8, and most preferably 4 to 8 groups. When the number of alkenyl groups is two, the aforementioned number n must be controlled so that the vinyl group content is 5% or more by mass. The specific value of n in such cases is 12 or less.

The organopolysiloxane of formula (8) can be one type or a mixture of two or more types. If two or more organopolysiloxanes are used as a mixture, the viscosity of the mixture at 25° C. is preferably the viscosity described above.

Furthermore, the compound of the aforementioned average composition formula (7) may be a branched organopolysiloxane expressed by the following average unit formula (9).

### Average Unit Formula:

(R₃SiO_{1/2})ₑ(R₂SiO_{2/2})_{f}(RSiO_{3/2})_{g}(SiO_{4/2})ₕ (9)

In formula (9), R is independently a group selected from alkenyl groups, monovalent hydrocarbon groups unsubstituted or substituted with fluorine, at least two of all Rs are alkenyl groups, (g+h) is a positive number, e is 0 or a positive number, and f is a number within a range of 0 to 100.

The alkenyl groups and monovalent hydrocarbon groups are as defined above for

formula (7). Furthermore, a preferred viscosity of the organopolysiloxane expressed by formula (9) is as specified above for the organopolysiloxane expressed by formula (7). Furthermore, the alkoxy group and silanol group may remain in the molecule to the extent that the object and effect of the present invention are not impaired.

The organopolysiloxane expressed by formula (9) preferably has 4 to 30, especially 6 to 20 silicon atoms per molecule.

The number of alkenyl groups of the organopolysiloxane expressed by formula (9) is preferably, as a whole, 2 to 10 on average per molecule, more preferably 3 to 10, particularly preferably 3 to 8, and most preferably 4 to 8 groups. As described above, if the number of alkenyl groups is two, the number of silicon atoms and the number of substituent groups must be controlled, and the molecular design must be such that the vinyl group content is 5% by mass or more.

In one preferred aspect, the organopolysiloxane of formula (9) is a branched organopolysiloxane containing units expressed by (RSiO_{3/2}).

Specific examples of the straight-chain organopolysiloxane expressed by the aforementioned formula (7) and especially formula (8) include double terminated dimethylvinylsilylpolydimethylsiloxane, double terminated dimethylvinylsilylpolydimethyl/diphenylsiloxane copolymer, double terminated dimethylvinylsilylpolymethylphenylsiloxane, double terminated dimethylhexenylsilyl polydimethylsiloxane, double terminated trimethylsilyl polydimethyl/methylvinylsiloxane copolymer, double terminated dimethylvinylsilyl polydimethyl/methylvinylsiloxane copolymer, double terminated trimethylsilyl polydimethyl/methylhexenylsiloxane copolymer, double terminated dimethylvinylsilylpolydimethyl/methylhexenylsiloxane copolymer, double terminated dimethylhexenylsilylpolydimethyl/methylhexenylsiloxane copolymer, double terminated silanolpolymethylhexenylsiloxane, double terminated trimethylsilyl polymethylhexenylsiloxane, double terminated dimethylvinylsilyl polymethylhexenylsiloxane, and double terminated dimethylhexenylsilyl polymethylhexenylsiloxane.

Specific examples of branched organopolysiloxanes expressed by the aforementioned formula (7), especially formula (9) include polysiloxanes containing M^{Vi} (dimethylvinylsiloxy) units and T (methylsiloxy) units, polysiloxanes containing M^{Vi} units and Q (siloxy) units, polysiloxanes containing M^{Vi} units, M (trimethylsilyl) units and Q units, polysiloxanes containing M^{Vi} units, D (dimethylsiloxy) units and T units, polysiloxanes containing M^{Vi} units, M units, and T units, polysiloxanes containing M^{Vi} units and T^{Ph} (phenylsiloxy) units, polysiloxanes containing M^{Vi} units, M units and T^{Ph} units, polysiloxanes containing M^{Vi} units, D units and T^{Ph} units, polysiloxanes containing M^{Hex} (dimethylhexenylsiloxy) units and T units, polysiloxanes containing M^{Hex} units and Q units, polysiloxanes containing M^{Hex} units, M units and Q units, polysiloxanes containing M^{Hex} units, D units and T units, polysiloxanes containing M^{Hex} units, M units and T units, polysiloxanes containing M^{Hex} units, and T^{Ph} units, polysiloxanes containing M^{Hex} units, M units and T^{Ph} units, polysiloxanes containing M^{Hex} units, D units and T^{Ph} units, polysiloxanes containing D^{Hex} (methylhexenylsiloxy) units and T units, polysiloxanes containing M units, D^{Hex} units, and T units, polysiloxanes containing D^{Hex} units, D units, and T units, polysiloxanes containing D^{Hex} units and T^{Ph} units, polysiloxanes containing D^{Hex} units, D units, and T^{Ph} units, polysiloxanes containing M units and D^{Hex} units and T^{Ph} units, polysiloxanes containing M units, D^{Hex} units, and Q units, polysiloxanes containing M units and T^{Hex} (hexenylsiloxy) units, polysiloxanes containing M units, D units, and T^{Hex} units, polysiloxanes containing D units and T^{Hex} units, polysiloxanes containing T^{Hex} units, polysiloxanes containing T^{Hex} units, and Q units, polysiloxanes containing M units, T^{Hex} units and Q units, polysiloxanes containing T^{Hex} units, and T units, polysiloxanes containing T^{Hex} units and T^{Ph} units, and polysiloxanes containing M units, T^{Hex} units, and T^{Ph} units.

The branched organopolysiloxanes containing alkenyl groups expressed by the aforementioned formulas (7) or (9) are particularly preferably alkenyl group-containing silsesquioxanes, where the alkenyl group is a C2-10 alkenyl group, preferably a C2-10 terminal alkenyl group, especially preferably a hexenyl group.

Furthermore, the aforementioned compound of formula (7) may be a cyclic organopolysiloxane expressed by formula (10)

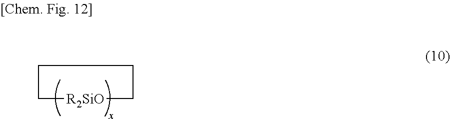

(in formula (10), R is independently a group selected from alkenyl groups and unsubstituted or fluorine-substituted monovalent hydrocarbon groups, x is an integer of 3 to 10, and at least two alkenyl groups are provided in the molecule).

The alkenyl group represented by R in formula (10) and the unsubstituted or fluorine-substituted monovalent hydrocarbon group are as defined for formula (7) above.

Furthermore, a preferred viscosity of the organopolysiloxane expressed by formula (10) is as specified above for the organopolysiloxane expressed by formula (7).

Specific examples of the cyclic organopolysiloxane expressed by formula (10) include 1,3,5,7-tetramethyl-1,3,5,7-tetravinylcyclotetrasiloxane, 1,3,5-trimethyl-1,3,5-trihexenylcyclotrisiloxane, 1,3,5,7-tetramethyl-1,3,5,7-tetrahexenylcyclotetrasiloxane, 1,3,5,7,9-pentamethyl-1,3,5,7,9-pentavinylcyclopentasiloxane, and 1,3,5,7,9-pentamethyl-1,3,5,7,9-pentahexenylcyclopentasiloxane.

The organopolysiloxane expressed by formulas (7), (8) to (10) can each be individually one type, or optionally a combination of two or more types as component (B). Component (B) is especially preferably one or more organopolysiloxane selected from the group consisting of the aforementioned organopolysiloxanes expressed by formula (8), branched organopolysiloxanes expressed by formula (9), and combinations thereof.

Compounds recommended as component (B) include one compound or a combination of two or more compounds selected from the group consisting of double terminated trimethylsilylpolydimethyl/methylhexenylsiloxane copolymer, double terminated dimethylvinylsilylpolydimethyl/methylhexenylsiloxane copolymer, double terminated dimethylhexenylsilylpolydimethyl/methylhexenylsiloxane copolymer, double terminated trimethylsilyl polymethylhexenylsiloxane, double terminated silanol polymethylhexenylsiloxane, polysiloxanes containing M units, D^{Hex} units and T units, polysiloxanes containing M units, D^{Hex} units and TPh units, polysiloxanes containing M^{Hex} units and T^{Ph} units, polysiloxanes containing M^{Hex} units, D units and T^{Ph} units, polysiloxanes containing M units and T^{Hex} units, polysiloxanes containing D units and T^{Hex} units, and polysiloxanes containing T^{Hex} units. Of these, polysiloxanes containing M units, D^{Hex} units and T^{Ph} units, polysiloxanes containing D^{Hex} units and T^{Ph} units, and polysiloxanes containing T^{Hex} units are particularly preferable.

### [Component (S2)]

As described above, component (S2) of the present invention is a mixture containing the aforementioned component (A) and component (B) at a mass ratio of 5:95 to 95:5 (A:B). In other words, the mixing ratio of component (A) and component (B) is 5 to 95% by mass of component (A) and 95 to 5% by mass of component (B) relative to 100% by mass of the total amount of component (A) and component (B). When the ratio of components (A) and (B) is within this range, a material can be designed where the viscosity of the curable composition will be appropriate, favorable UV curability is maintained, and the mechanical properties of the resulting cured product, especially tensile elongation, will be favorable. The hardness of the cured material can easily be designed to be high by increasing the ratio of component (A). The preferred ratio of component (A) is 15% to 85% by mass, more preferably 20 to 80% by mass, and even more preferably 25 to 75% by mass, inclusively, of the total amount of components (A) and (B).

### <Optional Components When Using Component (S2)>

If the aforementioned components (A) and (B) are used as component (S) in the UV curable composition of the present invention, a photoinitiator can be added if desired, in addition to component (A) and component (B). If the UV curable functional group of component (A) is a cationic polymerizable functional group, it is preferable to use a photocationic polymerization initiator that can be used when the UV curable functional group is a cationic functional group, as described in connection with the use of component (S1) as component (S) of the present invention. Herein, the aforementioned description of a photocation polymerizable initiator can be directly applied. Furthermore, if the UV curable functional group is a radical polymerizable group, a photoradical polymerization initiator is preferably used as the photopolymerization initiator. By using component (A) and the photoradical polymerization initiator generates free radicals by irradiating ultraviolet rays or electron beams, which trigger a radical polymerization reaction, to cure the composition of the present invention. When the composition of the present invention is cured by electron beam irradiation, a polymerization initiator is normally not required.

The photo-radical polymerization initiators are known to be broadly classified into photo-fragmentation and hydrogen abstraction types. However, the photo-radical polymerization initiator used in the composition of the present invention can be selected arbitrarily from those known in the technical field, and is not limited to any particular one. Examples of photoradical polymerization initiators include, but are not limited to, acetophenone, p-anisyl, benzyl, benzoin, benzophenone, 2-benzoylbenzoic acid, 4,4′-bis(diethylamino)benzophenone, 4,4′-bis(dimethylamino) benzophenone, benzoin methyl ether, benzoin isopropyl ether, benzoin isobutyl ether, benzoin ethyl ether, 4-benzoylbenzoic acid, 2,2′-bis(2-chlorophenyl)-4,4′,5,5′-tetraphenyl-1,2′-biimidazole, methyl 2-benzoylbenzoate, 2-(1,3-benzodioxol-5-yl)-4,6-bis(trichloromethyl)-1,3,5-triazine, 2-benzyl-2-(dimethylamino)-4′-morpholinobutyrophenone, (±)-camphorquinone, 2-chlorothioxanthone, 4,4′-dichlorobenzophenone, 2,2-diethoxyacetophenone, 2,2-dimethoxy-2-phenylacetophenone, 2,4-diethylthioxanthene-9-one, diphenyl(2,4,6-trimethylbenzoyl)phosphine oxide, ethyl(2,4,6-trimethylbenzoyl)phenyl phosphinate, 1,4-dibenzoylbenzene, 2-ethylanthraquinone, 1-hydroxycyclohexylphenyl ketone, 2-hydroxy-2-methylpropiophenone, 2-hydroxy-4′-(2-hydroxyethoxy)-2-methylpropiophenone, 2-isopropylthioxanthone, lithium phenyl(2,4,6-trimethylbenzoyl)phosphinate, 2-methyl-4′-(methylthio)-2-morpholinopropiophenone, 2-isonitrosopropiophenone, 2-phenyl-2-(p-toluenesulfonyloxy)acetophenone, and phenylbis(2,4,6-trimethylbenzoyl)phosphine oxide, and the like. Furthermore, in addition to the aforementioned compounds, examples of the photoradical polymerization initiators can include Omnirad (registered trademark) 651, 184, 1173, 2959, 127, 907, 369, 369E, and 379EG (alkylphenone photoradical polymerization initiator, IGM Resins B.V.), Omnirad (registered trademark) TPO H, TPO-L, and 819 (acyl phosphine oxide photoinitiators, IGM Resins B.V.), Omnirad (registered trademark) MBF and 754 (intramolecular hydrogen extraction type photoinitiators, IGM Resins B.V.), Irgacure (registered trademark) OXE01 and OXE02 (oxime ester non-associative polymerization initiator, BASF), and the like.

While the amount of the photoradical polymerization initiator added to the curable composition of the present invention is not particularly limited so long as the intended photopolymerization reaction or photo-curing reaction occurs, it is generally used at an amount of 0.01 to 5 mass %, and preferably 0.05 to 1 mass % relative to the total mass of the composition of the present invention.

Moreover, a photosensitizer may be used in combination with the aforementioned photoradical polymerization initiator. The use of a sensitizer can be expected to have an effect of increasing the photon efficiency of the polymerization reaction, similar to the case of where the aforementioned photocationic polymerization initiator is used. The aforementioned photosensitizers can be preferably used as examples of photosensitizers that can be used in combination with the photocationic polymerization initiators.

### [Component (S)]

Component (S) of the curable composition of the present invention includes one or more component selected from the aforementioned components (S1), or one or more component selected from components (S2). In other words, component (S) may include only component (S1) or only component (S2).

A particularly preferred aspect with respect to component (S) is as follows.
(1) Component (S) contains component (S1), and the number of UV curable functional groups of component (S1) averages 2 per molecule.
(2) Component (S) contains component (S1), and component (S1) is an organopolysiloxane having one UV curable functional group in the molecule.
(3) (i) Component (S) contains component (S1), and the UV curable functional group of component (S1) is a functional group selected from the group consisting of acryloxy group-containing groups, methacryloxy group-containing groups, epoxy group-containing groups, oxetane group-containing groups, and vinylether group-containing groups.
(ii) Component (S) contains component (S2), and the UV curable functional group of component (A) in component (S2) is a functional group selected from the group consisting of acryloxy group-containing groups, methacryloxy group-containing groups, epoxy group-containing groups, oxetane group-containing groups, and vinylether group-containing groups.
(4) Component (S) contains component (S1), and the UV curable functional group of component (S1) is an epoxy group-containing group. Preferably, component (S1) contains only epoxy-functional organopolysiloxane or includes epoxy-functional organopolysiloxane.
(5) Component (S) contains component (S2), and component (A) of component (S2) is a compound having an acryloxy group as the UV curable functional group and having a silicon atom and/or a compound having an acryloxy group as the UV curable functional group and not having a silicon atom.
(6) Component (S) contains component (S2), and component (A) of component (S2) is a compound having an acryloxy group as the UV curable functional group and having a silicon atom and/or a compound having an acryloxy group as the UV curable functional group and not having a silicon atom, and component (B) is an organopolysiloxane having an alkenyl group. In this case, component (A) more preferably is a compound not having a silicon atom.
(7) Component (S) contains component (S2), and component (A) of component (S2) is one compound or a mixture of two or more compounds having one acryloxy group as the UV curable group.
(8) Component (S) contains component (S2), and component (A) of component (S2) is a mixture of one or more compounds having one acryloxy group as the UV curable group and one or more compounds having two or more acryloxy groups as UV curable groups.
(9) Component (S) contains component (S2), and component (A) of component (S2) is a compound having one or more acryloxy groups as the UV curable group, and not having a silicon atom.
(10) Component (S) contains component (S2), and component (B) of component (S2) is an organopolysiloxane having (RSiO_{3/2}) units or contains an organopolysiloxane having (RSiO_{3/2}) units. In this case, component (B) is preferably an alkenyl group-containing silsesquioxane.
(11) Component (S) contains component (S2), and component (B) of component (S2) is an organopolysiloxane having three or more alkenyl groups in the molecule, or contains an organopolysiloxane having three or more alkenyl groups in the molecule. In this case, component (B) is preferably an alkenyl group-containing silsesquioxane.
(12) Component (S) is made of component (S2), and component (B) of component (S2) is an organopolysiloxane having an alkenyl group, and the alkenyl group is preferably an alkenyl group with 3 to 8 carbon atoms.

Any two or more of the aforementioned preferred aspects (1) through (12) may be combined together as long as the aspects do not contradict each other, and may be further combined with all of the above provisions for component (S) as long as they do not contradict those aspects.

The amount of component (S) is 90 to 99.99 parts by mass, preferably 93 to 99.99 parts by mass, and more preferably 95 to 99.99 parts by mass, relative to 100 parts by mass of the total amount including component (C) as described below.

The total amount of component (S) and component (C) is preferably 95 to 100 parts by mass, more preferably 97 to 100 parts by mass, relative to the total mass of the UV curable composition.

### <Component (C): UV Absorbent Compound>

The UV absorbent compound of component (C) of the present invention is a component that absorbs UV light in the cured product obtained from the UV curable composition, and provides an effective UV shielding effect. UV absorbent compounds are well known in the art, and many types of UV absorbent compounds are commercially available as so-called UV absorbing agents. A UV absorbent compound that has good miscibility with component (S) is preferably used in the UV curable composition of the present invention. The type and amount of component (C) can be adjusted so that the cured product with a thickness of 10 μm, obtained by curing the UV curable composition of the present invention, exhibits a light transmittance of 98% or higher at a visible light wavelength of 450 nm. On the other hand, the type and amount of component (C) can be adjusted to provide favorable UV shielding effects and have the lowest value for light transmittance in the aforementioned cured product of 50% or less in the UV wavelength range of 360 to 405 nm. As long as these conditions are satisfied, there is no restriction on the chemical structure of the UV absorbent compound of component (C), but the compound preferably has a maximum absorption wavelength in the wavelength range of 340 to 420 nm.

Examples of the ultraviolet absorbent compound in component (C) include triazine compounds, benzotriazole compounds, benzophenone compounds, oxybenzophenone compounds, salicylic acid ester compounds, cyanoacrylate compounds, as well as amino-substituted pyrimidine compounds, at these can be used individually, or as a combination of two or more types. Of these, heterocyclic compounds having a nitrogen atom such as triazine compounds, benzotriazole compounds, and amino-substituted pyrimidine compounds, are preferably used.

Specific examples of component (C) can be a triazole compound such as: 2,4-bis-[{4-(4-ethylhexyloxy)-4-hydroxy}-phenyl]-6-(4-methoxyphenyl)-1,3,5-triazine (Tinosorb S, manufactured by BASF), hydroxyphenyl-s-triazine (TINUVIN (registered trademark) 477, manufactured by BASF), 2,4-bis[2-hydroxy-4-butoxyphenyl]-6-(2,4-dibutoxyphenyl)-1,3,5-triazine (TINUVIN (registered trademark) 460, manufactured by BASF), reaction product of 2-(4,6-bis(2,4-dimethylphenyl-1,3,5-triazine-2-yl)-5-hydroxyphenyl and [(C10-C16 (mainly C12-C13)alkyloxy)methyl]oxirane (TINUVIN (registered trademark) 400, manufactured by BASF), reaction product of 2-[4,6-bis(2,4-dimethylphenyl)-1,3,5-triazine-2-yl]-5-[3-(dodecyloxy)-2-hydroxypropoxy]phenol), 2-(2,4- dihydroxyphenyl)-4,6-bis-(2,4-dimethylphenyl)-1,3,5-triazine and (2-ethylhexyl)-glycidic acid ester (TINUVIN (registered trademark) 405, manufactured by BASF), 2-(4,6-diphenyl-1,3,5-triazine-2yl)-5-(hexyl)oxy]-phenol (TINUVIN (registered trademark) 1577, manufactured by BASF), 2-(4,6-diphenyl-1,3,5-triazine-2-yl)-5-[2-(2-ethylhexanoyloxy)ethoxy]-phenol (ADK STAB LA46, manufactured by ADEKA), 2-(2-hydroxy-4-[1-octyloxycarbonyl ethoxy]phenyl)-4,6-bis(4-phenylphenyl)-1,3,5-triazine (TINUVIN (registered trademark) 479, manufactured by BASF), and other triazine compounds, 2-(2H benzotriazol-2-yl)-6-(1-methyl-1-phenylethyl)-4-(1,1,3,3-tetramethylbutyl)phenol (TINUVIN (registered trademark) 928, manufactured by BASF), an ester compound of 2-(2-hydroxy-5-tert-butylphenyl)-2H-benzotriazole TINUVIN (registered trademark) PS, manufactured by BASF), benzene propanoic acid and 3-(2H-benzotriazol-2-yl)-5-(1,1-dimethylethyl)-4-hydroxy(C7-9 side chain and straight chain alkyl) (TINUVIN (registered trademark) 384-2, manufactured by BASF), 2-(2H-benzotriazol-2-yl)-4,6-bis(1-methyl -1-phenylethyl)phenol (TINUVIN 900, manufactured by BASF), 2-(2H-benzotriazol-2-yl)-6-(1-methyl-1-phenylethyl)-4-(1,1,3,3-tetramethylbutyl)phenol (TINUVIN (registered trademark) 928, manufactured by BASF), reaction product of methyl-3-(3-(2H-benzotriazol-2-yl)-5-t-butyl-4-hydroxyphenyl)propionate/polyethylene glycol 300 (TINUVIN (registered trademark) 1130, manufactured by BASF), 2-(2H-benzotriazol-2-yl)-p-cresol (TINUVIN (registered trademark) P, manufactured by BASF), 2-(2H-benzotriazol-2-yl)-4-6-bis(1-methyl-1-phenylethyl)phenol (TINUVIN (registered trademark) 234, manufactured by BASF), 2-[5-chloro(2H)-benzotriazol-2-yl]-4-methyl-6-(tert-butyl)phenol (TINUVIN (registered trademark) 326, manufactured by BASF), 2-(2H-benzotriazole-2-yl)-4,6-di-tert-pentylphenol (TINUVIN (registered trademark) 328, manufactured by BASF), 2-(2H-benzotriazol-2-yl)-4-(1,1,3,3-tetramethylbutyl)phenol (TINUVIN (registered trademark) 329, manufactured by BASF), reaction product of methyl 3-(3-(2H-benzotriazol-2-yl)-5-tert-butyl-4-hydroxyphenyl)propionate and polyethylene glycol 300 (TINUVIN (registered trademark) 213, manufactured by BASF), 2-(2H-benzotriazol-2-yl)-6-dodecyl-4-methylphenol (TINUVIN (registered trademark) 571, manufactured by BASF) and the like, but there is no restriction to these. Furthermore, in addition to the aforementioned compounds, an amino-substituted pyrimidine compound, such as FDB-009 (manufactured by Yamada Chemical Industry) can also be preferably used as the UV absorbing compounds of component (C).

The maximum absorption wavelength of the aforementioned component (C) is in the wavelength range of 340 to 420 nm, and more preferably is in the wavelength range of 350 to 405 nm. Herein, the maximum absorption wavelength refers to the absorption maximum wavelength that exhibits the largest absorbance among a plurality of absorption maxima, if any, in the UV/visible spectral absorption spectrum within the measurement range of 300 nm to 800 nm.

One type of component (C) may be used alone or as a mixture of two or more components, and the overall content is 0.01 to 10 parts by mass for 100 parts by mass of the curable composition. 0.1 to 8 parts by mass is preferable, and 1 to 6 parts by mass is more preferable. By setting the amount of UV absorbent compound added to the above range, the UV shielding function of the cured layer can be sufficiently demonstrated, and the UV absorbent compound does not interfere with UV curing of a curable composition with a thickness of 10 μm, thus allowing UV curing to proceed at a sufficient speed.

The cured product obtained from the UV curable composition of the present invention has favorable UV shielding function in the wavelength range of 360 to 405 nm, but the wavelength range that exhibits the lowest light transmittance in the measured range of UV/visible absorption spectrum from 300 nm to 800 nm is preferably 385 to 400 nm. In other words, in the cured product of the present invention, the largest UV shielding effect in the measured range of 300 nm to 800 nm is preferably in the wavelength range of 385 to 400 nm.

The cured product of the present invention has favorable UV shielding effect, and therefore the lowest value of light transmittance in the wavelength range of 360 to 405 nm for a 10 μm thick sample is 50% or less. However, the light transmittance value is preferably 25% or less, and even more preferable is 10% or less. The value of light transmittance can be adjusted by selecting the type of UV absorbing compound to be used as component (C) and by optimizing the amount added to the curable composition, while taking into account the UV curing properties of the present composition.

The cured product obtained from the curable composition of the present invention can be designed so that the desired physical properties of the cured product and the curing speed on the curable composition can be achieved and the viscosity of the curable composition is a preferred value, by appropriately adjusting the molecular chain length of component (S1) and component (A), the position of UV curable functional groups in the molecule, the molecular structure, the structure of component (B), and the number of alkenyl groups per molecule, as described above. Furthermore, the cured product obtained by curing the curable composition of the present invention is also included in the scope of the present invention. Furthermore, the shape of the cured product obtained from the composition of the present invention is not particularly limited, and it may be a thin film coating layer, may be a sheet-like molded product or the like, may be injected into a specific site of an article in an uncured state and then cured to form a filling material, or may be used as a sealing material for a laminated body, display device, or the like or as an intermediate layer. The cured product obtained from the composition of the present invention is particularly preferably in the form of a thin film coating layer, and is particularly preferably an insulating coating layer.

The curable composition of the present invention is suitably used as a coating agent or potting agent, in particularly an insulating coating agent or potting agent for an electronic device or electrical device.

The cured product obtained by curing the curable composition of the present invention is characterized by the optical transparency in the visible light range and the high UV shielding effect. The transmittance at a wavelength of 450 nm of a cured product with a thickness of 10 μm obtained from the curable composition of the present invention is 98% or higher, and the light transmittance at least at one point in the wavelength range of 360 to 405 nm can be 50% or lower, or can be 10% or lower. Furthermore, the cured product obtained from the curable composition of the present invention also has excellent mechanical properties, especially tensile properties. When evaluated at a tensile speed of 50 mm/minute at 25° C. using a 10 mm thick test piece, the tensile elongation is usually 10% or more. By optimizing the components of the curable composition, the tensile elongation of the cured product can be increased to 50% or more, and thus the curable composition of the present invention is useful as a layer forming material for flexible displays.

If desired, the cured product obtained by curing the curable composition of the present invention can be designed to have a dielectric constant of less than 3.0, or less than 2.8, or the like, and the curable composition of the present invention can also be used to form a coating layer having a low dielectric constant.

When the curable composition of the present invention is used as a coating agent, the viscosity of the entire composition is preferably 500 mPa·s or less at 25° C., as measured using an E-type viscometer, in order for the curable composition to have suitable flowability and workability for application to the substrate. The preferred viscosity range is 5 to 100 mPa·s, more preferably 5 to 60 mPa·s, especially 5 to 30 mPa·s, and most preferably 5 to 20 mPa·s. The viscosity of the entire curable composition can be adjusted to the desired viscosity by using compounds with a preferred viscosity as each component so that the viscosity of the entire composition has the desired viscosity.

The curable composition of the present invention can achieve a suitable viscosity for a coating without substantial use of an organic solvent by using each of the aforementioned components, and in particular, the curable composition of the present invention preferably is substantially free of organic solvent. In the present specification, the phrase “essential not containing an organic solvent” that the amount of organic solvents is less than 0.05% by mass of the total composition, preferably less than the analytical limit of analytical methods such as gas chromatography or the like.

### [Component (E)]

When the UV curable composition of the present invention is applied to a surface of a substrate as a coating agent using an arbitrary method, in order to improve the wettability of the composition on the substrate and to form a defect-free coating film, component (E) selected from the following can be further added to the composition of the present invention containing the aforementioned components. The use of inkjet printing is particularly preferred as a method for coating the composition of the present invention on a substrate. Therefore, component (E) is a component that improves the wettability of the UV curable organopolysiloxane composition of the present invention on a substrate, and particularly significantly improves inkjet printing properties. Component (E) is at least one type of compound selected from a group consisting of the following (E1), (E2), and (E3).
(i) Component (E1)
Component (E1) is a nonionic surfactant that does not contain a silicon atom and is not acrylic, in other words, a nonacrylic nonionic surfactant. “Nonacrylic” means that the surfactant does not have a (meth)acrylate group in a molecule thereof. Examples of surfactants that can be used as component (E1) include glycerol fatty acid esters, sorbitan fatty acid esters, polyoxyethylene alkyl ethers, polyoxyethylene alkyl phenyl ethers, alkyl glycosides, acetylene glycol polyether, and other organic nonionic surfactants, fluorine-based nonionic surfactants, and the like, and one or a combination of two or more types thereof can be used. Specific examples of component (E1) include the EMULGEN Series and RHEODOL series manufactured by Kao Corporation, SURFYNOL 400 series manufactured by Evonik Industries AG, OLFINE E series manufactured by Nissin Chemical Co., Ltd. as organic nonionic surfactants, FC-4400 series manufactured by 3M and MEGAFACE 550, and 560 series manufactured by DIC Corporation as fluorine-based nonionic surfactants.
Of these, SURFYNOL 400 series and OLFINE E series, which are alkynol polyethers, are particularly preferred.
(ii) Component (E2) is a nonionic surfactant containing a silicon atom and having an HLB value of 4 or less. Herein, the HLB value is a value that expresses the degree of affinity of a surfactant to water and organic compounds, and herein, a value defined by the Griffin method (20× sum of the formula weight of the hydrophilic portion/molecular weight) is used as the HLB value. Silicone polyether having a polyether as a hydrophilic portion, glycerol silicone having a (di)glycerol derivative as a hydrophilic portion, carbinol silicones having a hydroxyethoxy group as a hydrophilic portion, and the like are known silicon-containing nonionic surfactants. Of these surfactants, those with an HLB value of 4 or less, in other words, those with a hydrophilic portion mass fraction of 20 mass % or less, are preferably used in the composition of the present invention. Of these, carbinol silicone is particularly preferred.
(iii) Component (E3) is a silicone oil having a viscosity of 90 mPa-s or less at 25° C. Examples of silicone oils include both-end terminated trimethylsilyl-polydimethylsiloxane, both-end terminated dimethylvinylsilyl-polydimethylsiloxane, both-end terminated trimethylsilyl-dimethylsiloxy/methylvinylsiloxy copolymers, both-end terminated dimethylvinylsilyl-dimethylsiloxy/methylvinylsiloxy copolymers, both-end terminated trimethylsilyl-dimethylsiloxy/methylphenylsiloxy copolymers, both-end terminated trimethylsilyl-dimethylsiloxy/diphenylsiloxy copolymers, both-end terminated dimethylvinylsilyl-dimethylsiloxy/methylphenylsiloxy copolymers, both-end terminated dimethylvinylsilyl-dimethylsiloxy/diphenylsiloxy copolymers, and the like. Both-end terminated trimethylsilyl-polydimethylsiloxane and both-end terminated dimethylvinylsilyl-polydimethylsiloxane can be preferably used. A preferred viscosity range of the silicone oil is 2 to 50 mPa-s. A more preferred range is 2 to 30 mPa-s, and an even more preferred viscosity range is 5 to 20 mPa-s. Note that viscosity values herein were measured at 25° C. using a rotational viscometer described in the Examples.

Components (E1) through (E3) described above can be one or a combination of two or more thereof. The amount of component (E) in the curable composition is not particularly limited, but the total of components (E1) to (E3) (collectively referred to as component (E)) is preferably 0.05 mass % or more and 1 mass % or less relative to the total amount of 100 mass % of the aforementioned component (S1), component (A), component (B), component (C), and component (D). This is because if the amount of component (E) is less than 0.05 mass % relative to a total amount of 100 mass % of components (A) to (C), an effect of improving the wettability of the curable composition to a substrate may not be sufficient, and if the amount of component (D) exceeds 1 mass % relative to the aforementioned total amount of 100 mass % of components (S1), component (A), component (B), component (C), and component (D), there is a risk that component (E) may bleed out from a cured product after curing.

As component (E), a silicone oil of component (E3) is preferably used alone, or component (E3) is preferably used in combination with one more component selected from a group consisting of component (E1) and component (E2). Component (E3) is preferably used alone as component (E).

### Other Additives

In addition to the aforementioned components, an additional additive may be added to the composition of the present invention if desired. Examples of additives include, but are not limited to, those described below.

### [Adhesion Imparting Agent]

An adhesion promoter can be added to the composition of the present invention to improve adhesion and close fitting properties to a substrate in contact with the composition. When the curable composition of the present invention is used for applications such as coating agents, sealing materials, and the like that require adhesion or close fitting properties to a substrate, an adhesion imparting agent is preferably added to the curable composition of the present invention. An arbitrary known adhesion promoter can be used, so long as the adhesion promoter does not interfere with a curing reaction of the composition of the present invention.

Examples of such adhesion promoters that can be used in the propyl include: organosilanes having a trialkoxysiloxy group (such as a trimethoxysiloxy group or a triethoxysiloxy group) or a trialkoxysilylalkyl group (such as a trimethoxysilylethyl group or triethoxysilylethyl groups) and a hydrosilyl group or an alkenyl group (such as a vinyl group or an allyl group), or organosiloxane oligomers having a straight chain structure, branched structure, or cyclic structure with approximately 4 to 20 silicon atoms; organosilanes having a trialkoxysiloxy group or a trialkoxysilylalkyl group and a methacryloxyalkyl group (such as a 3-methacryloxypropyl group), or organosiloxane oligomers having a straight chain structure, branched structure, or cyclic structure with approximately 4 to 20 silicon atoms; organosilanes having a trialkoxysiloxy group or a trialkoxysilylalkyl group and an epoxy group-bonded alkyl group (such as a 3-glycidoxypropyl group, a 4-glycidoxybutyl group, a 2-(3,4-epoxycyclohexyl)ethyl group, or a 3-(3,4-epoxycyclohexyl)propyl group), or organosiloxane oligomers having a straight chain structure, branched structure, or cyclic structure with approximately 4 to 20 silicon atoms; organic compounds having two or more trialkoxysilyl groups (such as trimethylsilyl groups or triethoxysilyl groups); reaction products of aminoalkyltrialkoxysilane and epoxy group-bonded alkyltrialkoxysilane, and epoxide groups-containing ethyl polysilicate. Specific examples thereof include vinyl trimethoxysilane, allyl trimethoxysilane, allyl triethoxysilane, hydrogen triethoxysilane, 3-glycidoxypropyl trimethoxysilane, 3-glycidoxypropyl triethoxysilane, 2-(3,4-epoxycyclohexyl)ethyl trimethoxysilane, 3-methacryloxypropyl trimethoxysilane, 3-methacryloxypropyl triethoxysilane, 1,6-bis(trimethoxysilyl)hexane, 1,6-bis(triethoxysilyl)hexane, 1,3-bis[2-(trimethoxysilyl)ethyl]-1,1,3,3-tetramethyldisiloxane, reaction products of 3-glycidoxypropyl triethoxysilane and 3-aminopropyl triethoxysilane, condensation reaction products of a methylvinyl siloxane oligomer blocked with a silanol group and a 3-glycidoxypropyl trimethoxysilane, condensation reaction products of a methylvinyl siloxane oligomer blocked with a silanol group and a 3-methacryloxypropyl triethoxysilane, tris(3-trimethoxysilylpropyl)isocyanurate.

The amount of the adhesion promoter to be added to the curable composition of the present invention is not particularly limited. However, since it does not promote curing properties of the curable composition or discoloration of a cured product, the amount is preferably within a range of 0.01 to 5 parts by mass, or within a range of 0.01 to 2 parts by mass, relative to a total of 100 parts by mass of component (S1), component (A), component (B), component (C), and component (D).

### [Additional Optional Additives]

Another additive may be added to the composition of the present invention in addition to or in place of the adhesion imparting agent described above, if desired. Examples of additives that can be used include leveling agents, silane coupling agents not included in those listed above as adhesion imparting agents, UV absorbers, antioxidants, polymerization inhibitors, fillers (reinforcing fillers, insulating fillers, thermally conductive fillers, and other functional fillers), and the like. If necessary, an appropriate additive can be added to the composition of the present invention. Furthermore, a thixotropy imparting agent may also be added to the composition of the present invention if necessary, particularly when used as a potting agent or sealing agent.

### [Application]

The UV curable composition of the present invention can be cured not only by ultraviolet rays but also by electron beams, which is another aspect of the present invention.

The curable composition of the present invention has low viscosity, and particularly useful as a material for forming an insulating layer for various articles, particularly electronic and electrical devices. The composition of the present invention can be applied on a substrate or sandwiched between two substrates, at least one of which includes a material that allows ultraviolet rays or electron beams to pass, and the composition can be cured by irradiating ultraviolet rays or electron beams to form an insulating layer. In this case, the composition of the present invention can be patterned when applied to a substrate, and then the composition can be cured. Alternatively, the composition can be applied to a substrate, and cured and uncured portions can be left during curing by ultraviolet rays or electron beam irradiation. Thereafter, an uncured portion can be removed with a solvent to form an insulating layer having a desired pattern. In particular, when the cured layer of the present invention is an insulating layer, the layer can be designed to have a low dielectric constant of less than 3.0.

The curable composition of the present invention provides favorable transparency of the cured product obtained therefrom, particularly suitable as a material for forming an insulating layer for touch panels and displays and other display devices. In this case, an arbitrary desired pattern may be formed as described above if necessary on the insulating layer. Therefore, a display device such as touch panel, display, or the like containing an insulating layer obtained by curing the UV curable organopolysiloxane composition of the present invention is also an aspect of the present invention.

Furthermore, the curable composition can also be used to form an insulating coating layer (insulating film) by curing after coating an article. Therefore, the composition of the present invention can be used as an insulating coating agent. Furthermore, a cured product formed by curing the curable composition of the present invention can be used as an insulating coating layer.

An insulating film formed from the curable composition of the present invention can be used for various applications. In particular, use is possible as a component of an electronic device or as a material used in a process of manufacturing the electronic device. Electronic devices include semiconductor devices, magnetic recording heads, and other electronic apparatuses. For example, the curable composition of the present invention can be used in an insulating film of a semiconductor device, such as an LSI, system LSI, DRAM, SDRAM, RDRAM, D-RDRAM, or a multi-chip module multilayer circuit board, an interlayer insulating film for a semiconductor, an etch stopper film, a surface protection film, a buffer coat film, a passivation film in LSI, a cover coat for a flexible copper cladding plate, a solder resistant film, and a surface protection film for an optical device.

Furthermore, the UV curable composition of the present invention can be used as a coating agent, or as a potting agent, and particularly as an insulating potting agent for electronic devices and electrical devices.

The composition of the present invention can be used as a material for forming a coating layer on a surface of a substrate, particularly using an inkjet printing method. In this case, the composition of the present invention particularly preferably contains component (E) described above.

The present invention is further described below based on Examples, but the present invention is not limited to the Examples below.

### EXAMPLES

The UV curable composition of the present invention and a cured product thereof of the present invention will be described below in further detail using examples. Furthermore, measurements and evaluations in the Examples and Comparative Examples were conducted as follows.

### [Viscosity of Curable Composition]

The viscosity (mPa·s) of the composition at 25° C. was measured using a rotary viscometer (E type viscometer VISCONIC EMD produced by TOKIMEC CORPORATION).

### [Appearance of Curable Composition and Cured Product Obtained Therefrom]

The appearance of the curable composition and cured product obtained therefrom were observed and visually evaluated.

### [Preparation of Curable Composition]

Each material at the amounts (parts by mass) listed in Table 1 below was placed in a brown plastic container and mixed well using a planetary mixer to prepare a curable composition.

### [Curing of Curable Composition and Measurement of Transmittance]

The cured product was prepared by placing approximately 0.02 g of the curable composition between two sheets of optical glass with a thickness of 0.7 mm, and curing the composition by irradiating with LED light at a wavelength of 405 nm wavelength at an energy intensity of 4 J/cm² (in other words, integrated light intensity) from the outside through one of the glass sheets to produce a cured product with a diameter of 40 to 45 mm and a thickness of 10±1 μm (micrometer). Transmittance (units: %) in the sample was measured at 25° C. using a V-650 UV/Visible light spectrophotometer manufactured by Japan Spectroscopic Instruments Co. The measurement range of the transmittance was 300 nm to 800 nm.

### [Wettability of Curable Organopolysiloxane Composition on Substrate (Contact Angle of Composition)]

Two microliters of the curable composition was dripped onto a silicon nitride coated glass substrate, and the contact angle of the curable composition immediately after dripping and 15 seconds after dripping was measured at 23° C. using a contact angle (units: °) measuring device DM-700 manufactured by Kyowa Interface Science Co., Ltd.

### [Curing the Curable Composition and Preparation of Samples for Dielectric Constant Measurement]

A mold having a thickness of 1 mm having circular holes with an inner diameter of 40 mm was placed on a PET film coated with a fluoropolymer release agent, and approximately 1.3 g of the curable composition was poured into a hole thereof. A PET film similar to that described above was placed over the composition, and a 10 mm thick glass plate was placed thereon. By irradiating an LED light having a wavelength of 405 nm at an energy amount of 4 J/cm² from above, the composition was cured to prepare a disk-shaped organopolysiloxane cured product having a diameter of 40 mm and a thickness of 1 mm.

### [Dielectric Constant of Organopolysiloxane Cured Product]

A tin foil having a diameter of 33 mm and a thickness of 0.007 mm was pressed onto both surfaces of the prepared organopolysiloxane cured product. In order to improve close fitting properties between the cured product and the foil, a small amount of silicone oil, if necessary, was used for pressing. The capacitance at room temperature and 100 KHz was measured by an E4990A precision impedance analyzer manufactured by Keysight Technologies to which a parallel plate electrode having a diameter of 30 mm was connected. The dielectric constant was calculated using measured capacitance values, separately measured thicknesses of the cured product, and electrode area values.

### Examples and Comparative Examples

The UV curable compositions were prepared at the compositions (parts by mass) shown in Table 1 using each of the following components.
(S1a) 1,3-bis[2-(3,4-epoxycyclohexyl)ethyl]-1,1,3,3-tetramethyldisiloxane
(S1b) 1,1,1,3,5,5,5-heptamethyl-3-[2-(3,4-epoxycyclohexyl)ethyl]trisiloxane
(A) Isobornyl acrylate
(B) Polyhexenyl silsesquioxane (average number of functional groups: 7.7)
(C1) Tinuvin (registered trademark) 384-2 (maximum absorption wavelength: 350 nm; manufactured by BASF)
(C2) Tinuvin (registered trademark) 477 (maximum absorption wavelength: 360 nm; manufactured by BASF)
(C3) FDB-009 (maximum absorption wavelength: 402 nm; manufactured by Yamada Chemical Industry)
(E) DOWSIL (registered trademark) SH 200 Fluid (20 cSt) (manufactured by Dow Chemical Company)
(F1) 4-isopropyl-4′-methyldiphenyliodonium tetrakis(pentafluorophenyl)borate
(F2) 2-isopropylthioxanthone
(F3) Omnirad (registered trademark) TPO-L (manufactured by IGM Resins)
(G) Dibutylhydroxytoluene

TABLE 1

| Component | Examples 1 | Example 2 | Example 3 | Example 4 | Example 5 | Example 6 | Examples 7 | Example 8 |
|---|---|---|---|---|---|---|---|---|
| (S1a) | 57.72 | 55.50 | 57.72 | 55.50 | | | | |
| (S1b) | 38.28 | 36.80 | 38.28 | 36.80 | | | | |
| (A) | | | | | 59.50 | 59.00 | 57.00 | 59.20 |
| (B) | | | | | 39.20 | 39.20 | 39.20 | 39.20 |
| (C1) | 1.96 | 5.66 | | | | | | |
| (C2) | | | 1.96 | 5.66 | | | | |
| (C3) | | | | | 0.50 | 1.00 | 3.00 | 0.50 |
| (E) | | | | | | | | 0.30 |
| (F1) | 2.0 | 2.0 | 2.0 | 2.0 | | | | |
| (F2) | 0.040 | 0.040 | 0.040 | 0.040 | | | | |
| (F3) | | | | | 0.50 | 0.50 | 0.50 | 0.50 |
| (G) | | | | | 0.30 | 0.30 | 0.30 | 0.30 |
| Total | 100.0 | 100.0 | 100.0 | 100.0 | 100.0 | 100.0 | 100.0 | 100.0 |
| Appearance of | Transparent | Transparent | Transparent | Transparent | Transparent | Transparent | Transparent | Transparent |
| curable | | | | | | | | |
| composition | | | | | | | | |
| Appearance of | Transparent | Transparent | Transparent | Transparent | Transparent | Transparent | Transparent | Transparent |
| cured product | | | | | | | | |
| Viscosity of | 18 | 20 | 18 | 20 | 19 | 19 | 20 | 19 |
| composition | | | | | | | | |
| Contact angle | | | | | 15 | | | 14 |
| of composition: | | | | | | | | |
| Immediately | | | | | | | | |
| after dripping | | | | | | | | |
| Contact angle | | | | | 8 | | | <5 |
| of composition: | | | | | | | | |
| 15 seconds | | | | | | | | |
| after dripping | | | | | | | | |
| Transmittance | 42.0 | 6.8 | 30.7 | 1.5 | 48.7 | 34.1 | 1.5 | 48.5 |
| of cured | | | | | | | | |
| product: 365 | | | | | | | | |
| nm | | | | | | | | |
| Transmittance | 95.1 | 85.8 | 82.7 | 52.2 | 29.1 | 18.2 | 0.1 | 29.0 |
| of cured | | | | | | | | |
| product: 395 | | | | | | | | |
| nm | | | | | | | | |
| Transmittance | >99 | >99 | >99 | >99 | >99 | >99 | >99 | >99 |
| of cured | | | | | | | | |
| product: 450 | | | | | | | | |
| nm | | | | | | | | |
| Dielectric | | | | | 2.5 | | | |
| constant of | | | | | | | | |
| cured product | | | | | | | | |

TABLE 2
Continued of Table 1

| | Comparative | Comparative | Comparative | Comparative |
|---|---|---|---|---|
| Component | Example 1 | Example 2 | Example 3 | Example 4 |
| (S1a) | 59.80 | | 51.58 | |
| (S1b) | 39.66 | | 34.28 | |
| (A) | | 60.00 | | 48.00 |
| (B) | | 39.20 | | 39.20 |
| (C1) | | | | |
| (C2) | | | 12.00 | 12.00 |
| (C3) | | | | |
| (E) | | | | |
| (F1) | 0.50 | | 2.00 | |
| (F2) | 0.040 | | 0.040 | |
| (F3) | | 0.50 | | 0.50 |
| (G) | | 0.30 | | 0.30 |
| Total | 100.0 | 100.0 | 100.0 | 100.0 |
| Appearance of curable composition | Transparent | Transparent | Transparent | Transparent |
| Appearance of cured product | Transparent | Transparent | Did not cure | Did not cure |
| Viscosity of composition | 17 | 19 | 21 | 21 |
| Transmittance of cured product: 365 nm | >99 | >99 | | |
| Transmittance of cured product: 395 nm | >99 | >99 | | |
| Transmittance of cured product: 450 nm | >99 | >99 | | |

As shown in Table 1, the UV curable compositions of the present invention (Examples 1 to 8) have viscosities at 25° C. that are suitable for application to substrates as coating agents, especially by inkjet printing, and the curable compositions and cured products obtained therefrom are highly transparent. Furthermore, the curable composition has favorable wettability to the substrate, but the addition of component (E) can further improve the wettability of the composition to the substrate. Furthermore, the UV shielding effect of the cured product obtained from the curable composition of the present invention in a given wavelength range (360 to 405 nm) is large, and the curable composition of the present invention has excellent UV curability. On the other hand, no UV shielding effect was observed in the compositions without component (C) (Comparative Examples 1 and 2). Furthermore, compositions with a large amount of component (C) (Comparative Examples 3 and 4) had inferior UV curability. Therefore, the curable composition of the present invention is characterized by the ability to be rapidly UV cured while at the same time providing a cured product with a large UV shielding effect.

### INDUSTRIAL APPLICABILITY

The UV curable composition of the present invention is particularly suitable for the applications described above, and particularly as a material for forming an insulating layer for display devices such as touch panels and displays, and particularly flexible displays which require increased product quality stability by shielding ultraviolet light with a wavelength of 360 to 405 nm.

1. A UV curable composition, comprising:
(S) 90 to 99.99 parts by mass of one or more of the following component (S1) or component (S2);
(S1) an organopolysiloxane and/or organosilane having a UV curable functional group,
(S2) a mixture containing
(A) a compound with a UV curable functional group, with or without silicon atoms, and
(B) an organopolysiloxane without a UV curable functional group, at a mass ratio of 5:95 to 95:5; and
(C) 0.01 to 10 parts by mass of a UV absorbing compound;
wherein the total of component (S) and component (C) is 100 parts by mass;
wherein when the composition is applied to an arbitrary substrate so that the thickness after curing is 10 μm, and light irradiation is performed such that the integrated light intensity at least at one wavelength selected from 365 to 405 nm is 2 to 8 J/cm², the composition can be cured upon completion of irradiation or within 5 minutes thereafter; and
wherein the resulting cured material with a thickness of 10 μm has a light transmittance of 98% or more at a wavelength of 450 nm and a light transmittance of 50% or less at least at one point in the wavelength range of 360 to 405 nm.

2. The UV curable composition according to claim 1, substantially free of organic solvents.

3. The UV curable composition according to claim 2, wherein the viscosity of the composition measured at 25° C. using an E-type viscometer is 500 mPa·s or less.

4. The UV curable composition according to claim 2, wherein the wavelength range where the cured material with a thickness of 10 μm exhibits the lowest light transmittance is 385 to 400 nm.

5. The UV curable composition according to claim 2, wherein component (C) is a compound having a maximum absorption wavelength in the 340 to 420 nm wavelength range.

6. The UV curable composition according to claim 1, wherein component (S1) and compound (A) of component (S2) having a UV curable functional group and having a silicon atom are silicon-containing compounds selected from the group consisting of straight chain, branched, or cyclic organosilanes and organopolysiloxanes expressed by the average composition formula:
R_{c}R′_{d}SiO_{(4-c-d)/2} (2)
where R is a UV curable functional group;
R′ is a group selected from monovalent hydrocarbons, hydroxyl groups, and alkoxy groups excluding the UV curable functional group;
c and d are numbers that satisfy the following conditions: 1<(c+d)≤4 and 0.05≤(c/(c+d))≤0.25, and the number of R in the molecule is 1.

7. The UV curable composition according to claim 1, wherein component (S1) and compound (A) of component (S2) having a UV curable functional group and having a silicon atom are silicon-containing compounds selected from the group consisting of straight chain, branched, or cyclic organosilanes and organopolysiloxanes expressed by the average composition formula:
RₐR′_{b}SiO_{(4-a-b)/2} (1)
where R is a UV curable functional group;
R′ is a group selected from monovalent hydrocarbons, hydroxyl groups, and alkoxy groups excluding the UV curable functional group;
a and b are numbers that satisfy the following conditions: 1≤(a+b)≤3 and 0.01≤(a/(a+b))≤0.34, and the number of R in the molecule is 2.

8. The UV curable composition according to claim 6, wherein component (S1) and compound (A) of component (S2) having a UV curable functional group and having a silicon atom are organopolysiloxanes and/or an organosilanes having one UV curable functional group in a molecule, selected from a group consisting of:
organopolysiloxanes expressed by the following formula (3′): 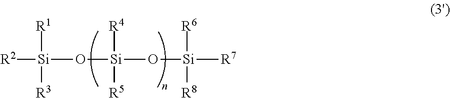
where in formula (3′), of all R¹ to R⁸ groups, only one UV curable functional group is present in the molecule; the other of R¹ to R⁸ groups are independently a monovalent hydrocarbon group unsubstituted or substituted with fluorine; and n is a numerical value that is 0 or higher and 3 or lower;
cyclic organopolysiloxanes expressed by the following formula (5′): 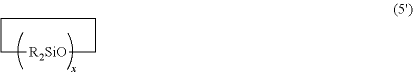
where in formula (5′), R is independently a group selected from UV curable functional groups and monovalent hydrocarbon groups unsubstituted or substituted with fluorine, x is an integer of 3 to 5, and only one UV curable functional group is provided in the molecule; and
organosilanes expressed by the following formula (6):
RSiR′₃ (6)
where in formula (6), R is a UV curable functional group, and R′ is a group selected from monovalent hydrocarbon groups, hydroxyl groups, and alkoxy groups excluding the aforementioned UV curable functional groups.

9. The UV curable composition according to claim 7, wherein component (S1) and compound (A) of component (S2) having a UV curable functional group and having a silicon atom are one or more organopolysiloxane having one UV curable functional group in a molecule, selected from a group consisting of:
organopolysiloxanes expressed by the following formula (3): 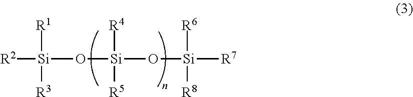
where in formula (3), two or more of all R¹ to R⁸ groups in one molecule are UV curable functional groups; other R¹ to R⁸ groups are independently, monovalent hydrocarbon groups unsubstituted or substituted with fluorine; and n is a numerical value such that the viscosity of the organopolysiloxane expressed by Formula (3) is 1 to 1000 mPa·s at 25° C., and n may be 0; and
organopolysiloxanes expressed by average unit formula:
(R₃SiO_{1/2})ₑ(R₂SiO_{2/2})_{f}(RSiO_{3/2})_{g}(SiO_{4/2})ₕ (4)
where in formula (4), R is independently a group selected from UV curable functional groups, monovalent hydrocarbon groups unsubstituted or substituted with fluorine, x is an integer between 3 and 10, at least two of all Rs are UV curable functional groups, (g+h) is a positive number, e is 0 or a positive number, and f is a number within a range of 0 to 20;
cyclic organopolysiloxanes expressed by the following formula (5): 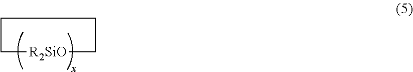
where in formula (5), R is independently a group selected from UV curable functional groups and monovalent hydrocarbon groups unsubstituted or substituted with fluorine, x is an integer of 3 to 10, and two or more UV curable functional groups are provided in the molecule; and
mixtures of two or more organopolysiloxanes arbitrarily selected therefrom.

10. The UV curable composition according to claim 7, wherein the number of UV curable functional groups of component (S1) and compound (A) of component (S2) in the composition is on average two per molecule.

11. The UV curable composition according to claim 6, wherein component (S1) and compound (A) of component (S2) in the composition are organopolysiloxanes having one UV curable functional group in the molecule.

12. The UV curable composition according to claim 1, wherein the UV curable functional group of component (S1) and compound (A) of component (S2) in the composition is a functional group selected from the group consisting of acryloxy group-containing groups, methacryloxy group-containing groups, epoxy group-containing groups, oxetane group-containing groups, and vinylether group-containing groups.

13. The UV curable composition according to claim 1, comprising component (S1) as component (S), and optionally wherein component (S1) is an epoxy-functional polysiloxane.

14. The UV curable composition according to claim 1, comprising component (S2) as component (S), and optionally wherein component (A) is a compound having an acryloxy group.

15-16. (canceled)

17. The UV curable composition according to claim 14, comprising component (S2), wherein component (A) is a compound having an acryloxy group and component (B) is an organopolysiloxane having an alkenyl group.

18-19. (canceled)

20. The UV curable composition according to claim 13, comprising component (S1), wherein
component (S1) is a mixture containing:
(S1-1) one or more organopolysiloxanes having on average two or more epoxy-containing groups per molecule; and
(S1-2) one or more organosilicon compounds selected from the group consisting of organopolysiloxanes and/or organosilanes having one epoxy group-containing group per molecule,
such that the mass ratio (S1-1/S1-2) of component (S1-1) and component (S1-2) is 100/0 to 0/100.

21. The UV curable composition according to claim 20, comprising component (S1), wherein component (S1) is:
(S1-2-1) 1,1,1,3,5,5,5-heptamethyl-3-[2-(3,4-epoxycyclohexyl)ethyl]trisiloxane; or
a mixture of (S1-2-1) 1,1,1,3,5,5,5-heptamethyl-3-[2-(3,4-epoxycyclohexyl)ethyl]trisiloxane and at least one compound selected from the following (S1-1-1) group, wherein the mass ratio is in a range of 100/0 to 0/100 (amount of S-2-1/total amount of the compound selected from the S1-1-1 group);
(S1-1-1):
1,3-bis[2-(3,4-epoxycyclohexyl)ethyl]-1,1,3,3-tetramethyldisiloxane, 1,5-bis[2-(3,4-epoxycyclohexyl)ethyl]-1,1,3,3,5,5-hexamethyltrisiloxane, 1,1,3,3,5,5,7,7,9,9-decamethyl-1,9-bis[2-(3,4-epoxycyclohexyl)ethyl]pentasiloxane, methyl(tris[2-(3,4-epoxycyclohexyl)ethyl]dimethylsiloxy)silane, tetrakis([2-(3,4-epoxycyclohexyl)ethyl]dimethylsiloxy)silane, 1,3,5,7-tetramethyl-1,3,5,7-tetra[2-(3,4-epoxycyclohexyl)ethyl]-cyclotetrasiloxane, 1,3-bis(3-glycidoxypropyl)-1 1,3,3-tetramethyldisiloxane, 1,5-bis(3-glycidoxypropyl)-1,1,3,3,5,5-hexamethyltrisiloxane, 1,1,3,3,5,5,7,7,9,9-decamethyl-1,9-bis(3-glycidoxypropyl)pentasiloxane, methyl[tris(3- glycidoxypropyl)dimethylsiloxy]silane, tetrakis[(3-glycidoxypropyl)dimethylsiloxy]silane, and 1,3,5,7-tetramethyl-1,3,5,7-tetra(3-glycidoxypropyl)-cyclotetrasiloxane.

22-24. (canceled)

25. The UV curable composition according to claim 14, comprising component (S2), wherein component (B) in the composition is one or more component selected from the following components (B1) and (B2):
(B1) organopolysiloxane having three or more alkenyl groups in one molecule and no UV curable functional groups; and
(B2) organopolysiloxane having two or more alkenyl groups in one molecule but not having a UV curable functional group, where the amount of vinyl groups is 5% or more by mass.

26. The UV curable composition according to claim 14, comprising component (S2), wherein component (B) in the composition is a straight-chain, branched, or cyclic organopolysiloxane expressed by the average composition formula:
RₐR′_{b}SiO_{(4-a-b)/2} (7)
where in formula (7), R is an alkenyl group;
R′ is a group selected from monovalent hydrocarbon groups excluding alkenyl groups, hydroxyl groups, and alkoxy groups;
a and b are numbers that satisfy the following conditions: 1≤(a+b)<3 and 0.1≤(a/(a+b))≤1.0, and at least two Rs are present in a molecule.

27. The UV curable composition according to claim 14, comprising component (S2), wherein the organopolysiloxane of component (B) in the composition is one or more type of organopolysiloxanes having 2 or more alkenyl groups in the molecule selected from a group consisting of: organopolysiloxanes expressed by the following formula (8): 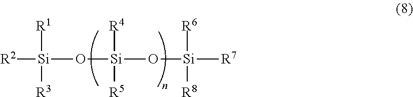
where in formula (8), of all R¹ to R⁸ groups, two or more alkenyl groups are present in the molecule; the other groups of R¹ to R⁸ are independently monovalent hydrocarbon groups that are unsubstituted or substituted with fluorine; and n is a numerical value that is 1 or more and 1000 or less;
organopolysiloxanes expressed by the following average unit formula:
(R₃SiO_{1/2})ₑ(R₂SiO_{2/2})_{f}(RSiO_{3/2})_{g}(SiO_{4/2})ₕ (9)
where in formula (9), R is independently a group selected from alkenyl groups and monovalent hydrocarbon groups that are unsubstituted or substituted with fluorine, at least two of all Rs are alkenyl group, (g+h) is a positive number, e is 0 or a positive number, and f is a number within a range of 0 to 100;
cyclic organopolysiloxanes expressed by the following formula (10): 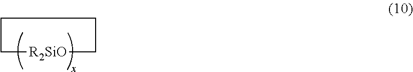
where in formula (10), R independently represents a group selected from alkenyl groups and monovalent hydrocarbon groups that are unsubstituted or substituted with fluorine, x is an integer from 3 to 10, and at least 2 groups in the molecule are alkenyl groups; and
mixtures of these organopolysiloxanes.

28-38. (canceled)
